(19) United States
(12) Patent Application Publication
(10) Pub. No.: US 2001/0044789 A1
(43) Pub. Date: Nov. 22, 2001

(54) Neurointerface for human control of complex machinery

(75) Inventors: Bernard Widrow, Stanford, CA (US); Marcelo M. Lamego, Irvine, CA (US)

Correspondence Address: FLEHR HOHBACH TEST ALBRITTON & HERBERT LLP, Suite 3400, Four Embarcadero Center, San Francisco, CA, 94111-4187, US

(73) Assignee: The Board of Trustees of the Leland Stanford Junior University

(21) Appl. No.: 09/782,898

(22) Filed: Feb. 13, 2001

Related U.S. Application Data
(60) Provisional application No. 60/183,688, filed on Feb. 17, 2000.

(51) Int. Cl. G06F 15/18

(52) U.S. Cl. 706/14

(57) ABSTRACT

A Neurointerface is a trainable filter based on neural networks that serves as a coupler between a human operator and a nonlinear system or plant that is to be controlled or directed. The purpose of the coupler is to ease the task of the human controller.

The Neurointerface can be adapted to be an inverse or an approximate inverse of the plant. The Neurointerface can be adapted so that when it is cascaded with the plant, the overall plant response closely approximates the human command input. In this way, it is easy for the human operator to direct the response of the plant.

A Neurointerface and a plant disturbance canceller have been applied to the steering system of a truck and trailer(s). The Neurointerface is used only while the truck is backing. Backing a truck with two or more trailers is essentially impossible for a professional truck driver, but is easily done by an unskilled driver when using the Neurointerface.

Neurointerface designs are presented for human control of construction cranes and multi-jointed robot arms. The same principles can be applied to ease human control of other complex machines such as aircraft, helicopters, heavy earth moving equipment, and so forth. Obstacle avoidance can also be done with Neurointerface control.

### RELATED APPLICATIONS

This application claims priority to provisional application serial No. 60/183,688 filed Feb. 17, 2000.

### FIELD OF THE INVENTION

This invention relates generally to the use of neural networks [1] [2] in the implementation of man-machine interfaces for human control of complex machinery. High-level commands of a human operator are fed to a Neurointerface whose output directly controls the subject machinery. Applied to the problem of backing a trailer-truck, a Neurointerface connected to the steering system of the truck enables a driver to easily back a truck with two or more trailers. This task is essentially impossible without the Neurointerface for even the most skilled truck driver. The same principles can be applied to ease human control of other complex machines.

### BACKGROUND OF THE INVENTION

For many tasks, productivity, safety, and liability conditions require a high degree of skill from human operators. In order to overcome a sometimes lack of skill, special man-machine interfaces may be utilized. The basic idea is to change the operational space through a neural network, allowing the human operator to interact with the process through less-specialized commands. Hence, the operator devotes his attention to solving a less complex problem, directly at the task level. The objective is to improve productivity and safety, even when working with unskilled operators.

Neural networks have been trained to serve as man-machine interfaces for human control of complex machinery. A Neurointerface has been applied to the steering system of a truck and trailer(s) to allow a driver to steer while backing. The steering commands of the human driver are fed to the Neurointerface whose output controls the steering angle of the front wheels of the truck.

The term “Neurointerface” is chosen to emphasize the use of neural networks for man-machine interfaces. Neurointerfaces can be used to facilitate human control of trucks, construction cranes, multi-joined robot arms, aircraft, and other complex systems.

In the language of Automatic Control Theory, the word “plant” refers to the system to be controlled. In the present context, complex machinery to be controlled is referred to as the plant.

A Neurointerface may be thought of as a form of inverse of the plant to be controlled. A desired plant response can be realized by driving the plant with an inverse controller whose input consists of simple command signals applied by a human operator. Thus, an unskilled operator using a Neurointerface can reproduce the actions of an experienced operator.

The design of Neurointerfaces involves the training of neural networks, which are incorporated in nonlinear adaptive filters. One searches for the set of parameters (neural network weights) that are best solutions for a predefined cost function (mean-square error). The Backpropagation algorithm [3] is used in this work for the design of Neurointerfaces.

The change of operational space made by the Neurointerface allows the human operator to interact with the process through easier less-specialized actions. This is the case, for instance, in backing the truck and trailers. The Neurointerface may be considered as a black box that takes commands from the driver (desired direction of the trailer back part) and provides the necessary actions (steer the wheels) in order to achieve such a goal. Knowledge of the angle between the cab and the trailer is sufficient to control the steering while backing. The angle between cab and first trailer and the angle between first and second trailer contain sufficient information to perform the control of a backing truck with two trailers, and so forth.

It should be noted that the driver is not eliminated in this work. Nguyen and Widrow [1] [4] proposed a neural network that provided full automation in backing a trailer truck to a loading dock and indeed, eliminating the need for a driver. With the present invention, human action is required and is beneficial. In fact, the driver is concerned with providing high-level direction for the desired spatial trajectory, free of obstacles and normally the shortest path.

Backing a truck and a single trailer requires a good deal of experience and skill on the part of the truck driver. Backing a truck and two trailers in tandem is practically impossible for a human driver. These configurations are unstable and very difficult to control when going straight back or when backing around a curve. With a suitably designed controller that serves as an interface between the driver and the steering gear of the truck, it becomes as easy to steer a backing truck with one or more trailers as it is to steer a car going forward.

When a car is going forward and the angle of the steering wheel is held fixed, the angle of the front wheels relative to the forward axis of the car is fixed and the car travels in a circle having a given radius of curvature. If the angle of the steering wheel is suddenly changed and again held fixed, the car will travel in a new circle with a new radius of curvature. Under normal forward driving conditions, the driver of the car is almost continuously changing the angle of the steering wheel. The steering angle determines the instantaneous radius of curvature. By controlling the radius of curvature, the driver is able to steer the car along any desired path.

In accord with the present invention, the driver of a backing truck and trailer(s) will apply steering commands to a controller that will adjust the steering angle of the front wheels of the truck so that the truck and trailer combination will back in circles having a given radius of curvature. If the driver decides to hold the steering command fixed, the truck and trailer(s) will back along a circle of fixed radius of curvature. If the steering command is suddenly changed, the controller causes a steering transient to take place with the front wheels of the truck in order to properly position the relative angles of the truck and trailer(s) for backward travel along a new circle having the desired radius of curvature.

With the car going forward or backward, a sudden change in steering command causes a sudden change in radius of curvature. With the backing truck and trailer configuration, a sudden change in steering command causes a change in radius of curvature, after the steering transient is finished. Backward travel of a distance approximately equal to the length of the truck and trailer(s) is required to completely finish the transient. Continual changing of the steering command causes backing not along a perfect circle but along a path having an average radius of curvature. By maintaining the steering command, the truck driver is able to steer the backing truck and trailer(s) along any desired path.

Control systems for tractor/trailer rigs that prevent jackknife and allow steering while backing have been proposed in the prior art. A system invented by Breen (U.S. Pat. No. 5,001,639) uses braking control on the wheels of the trailer to prevent jackknifing when going forward at high speed. This differs from the present invention in that the control does not steer the truck and trailer while backing. An invention by Kendall (U.S. Pat. No. 5,247,442) does steer the truck and trailer while backing. Kendall's control system differs from the present invention in that his system backs the truck and trailer toward a fixed target. The present invention backs the truck and trailer(s) combination so that it follows a circular path of controlled radius of curvature determined by the steering command of the driver. The truck and trailer(s) are free to back continuously along any desired path, not necessarily toward a fixed target. An invention by Mclaughlin (U.S. Pat. No. 5,282,641) allows a truck and trailer to negotiate a tighter turn around a corner by manipulating a platform that is part of the fifth-wheel coupling between truck and trailer. This is a useful system, but it does not steer the front wheels of the truck while backing. Another invention by Juergens, et. al. (U.S. Pat. No. 5,690,347) prevents jackknifing by applying a controlled friction force to the braking system on the fifth-wheel coupler between truck and trailer, but this system also does not steer the front wheel of the trailer. The present invention allows the backward steering of a truck and trailer(s) along any desired path in a way that is very similar to the steering of a car going forward.

Using the Neurointerface technique, a unique combination of electronically implemented control algorithm, power amplifier, electrical drive motor, and coupling to the truck steering gear is provided. The truck driver steers with a joystick while backing, and steers with the usual truck steering wheel when going forward. Steering with the joystick during backing determines the direction of the rear of the trailer most distant from the truck. The control algorithm manages the intricate details of the steering sequence for the truck front wheels, while the driver controls the overall steering by giving high-level commands via the joystick, such as “rear-most trailer to the left”, or “to the right”, and how much. This is accomplished by controlling the curvature of the backing trajectory.

### OBJECTS AND SUMMARY OF THE INVENTION

It is an object of this invention to provide designs for Neurointerfaces that act as couplers between human operators and complex machinery to be controlled. A Neurointerface is a trainable nonlinear filter based on neural networks that learns to be the inverse of the plant to be controlled, thus making it easy for the human operator to direct the behavior of the plant. Adaptive algorithms for training Neurointerfaces are provided. Also provided are designs for plant disturbance cancellers for linear and nonlinear plants, and training algorithms for the canceller feedback element.

It is another object of this invention to provide the methodology by which a Neurointerface and a plant disturbance canceller can be connected to the steering system of a trailer-truck for use while the truck and trailer(s) are backing. This technology eases the backing task for the driver, and makes it possible for the driver to back up a truck with two or more trailers without first uncoupling the trailers and backing them one at a time. The same principles can be applied to ease human control of other complex machines, such as construction cranes, multi-link robot arms, aircraft, heavy earth moving equipment, and so forth.

### BRIEF DESCRIPTIONS OF THE DRAWINGS

FIG. 1 shows a human operator commanding a Neurointerface whose output drives the input of the plant to be controlled, in accordance with the invention.

FIGS. 2 (a)-2 (c) show a single neuron of the type used in the neural networks, a feedforward nonlinear adaptive filter incorporating a tapped delay line and a 3-layer neural network, and a nonlinear adaptive filter with both feedforward and feedback sections incorporating a 3-layer neural network.

FIG. 3 shows a schematic diagram of a truck and two trailers.

FIG. 4 shows the plant state-space representation, including stabilization feedback.

FIG. 5 shows an off-line learning process for training the Neurointerface.

FIG. 6 shows the Neurointerface, having been trained, connected to drive the plant.

FIG. 7 shows a trained Neurointerface driving a plant with a disturbance canceller.

FIG. 8 shows an off-line process for training the feedback box Q for the plant disturbance canceller.

FIG. 9 shows a trajectory of a backing truck with two trailers when the command input is sinusoidal.

FIGS. 10 (a)-10 (b) show, for a backing truck with two trailers, a sinusoidal command input signal, the reference model output, the angle θ₃ response, and the steering angle θ₁ of the truck front wheels, all plotted as functions of time.

FIGS. 11 (a)-11 (b) show, for a backing truck with two trailers, a sinusoidal command input, the reference model output, the angle θ₃ response, and the steering angle θ₁ of the truck front wheels, plotted versus time, when the truck has been subjected to vigorous disturbance.

FIG. 12 shows the trajectory of the backing truck with two trailers when subjected to vigorous disturbance.

FIG. 13 shows the controls in the cab of a large trailer truck capable of backing one or more trailers with joystick steering.

FIG. 14 shows the steering system of a large trailer truck capable of backing one or more trailers with joystick steering control through a Neurointerface.

FIG. 15 shows a construction crane that can be controlled by an operator using a Neurointerface.

FIG. 16 shows a robot arm that can be controlled by an operator using a Neurointerface.

FIG. 17 shows another Neurointerface embodiment, with the state feedback loop closed through the Neurointerface.

FIG. 18 shows a process for training a Neurointerface with the state feedback loop closed through it.

FIGS. 19 (a)-19 (b) show a truck and trailer with proximity sensors for obstacle detection, and an obstacle avoidance system for use with a Neurointerface.

FIG. 20 shows a construction crane trolley and load equipped with proximity sensors for obstacle detection and avoidance.

FIGS. 21 (a)-21 (c) show a multi-link robot arm with proximity or pressure sensors, system for control of the effector with obstacle avoidance or pressure minimization, and a joystick for control of the robot effector in two dimensions.

### DETAILED DESCRIPTION OF THE INVENTION

The present invention will be described more fully hereinafter with reference to the accompanying drawings, in which preferred embodiments of the invention are shown. This invention can, however, be embodied in many different forms and should not be construed as limited to the embodiments set forth herein. This disclosure will fully convey the scope of the invention to those skilled in the art.

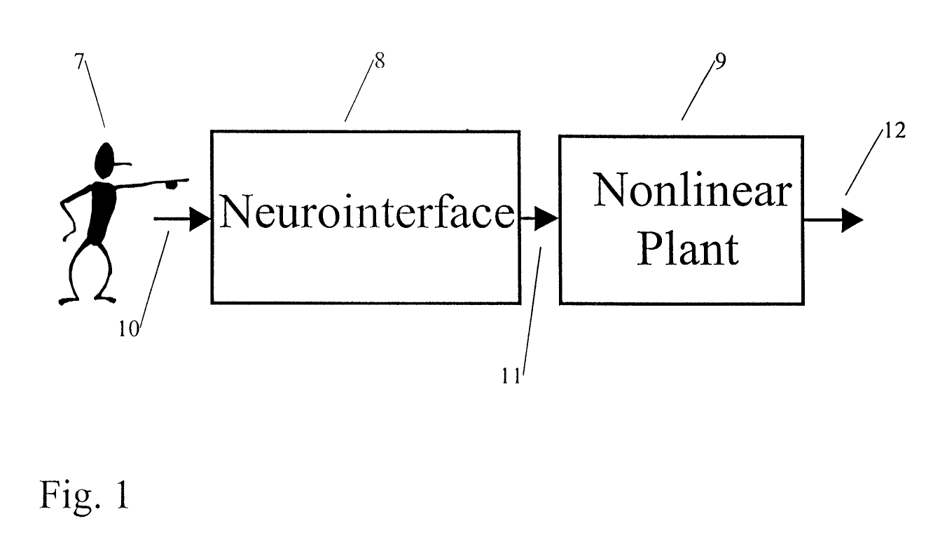

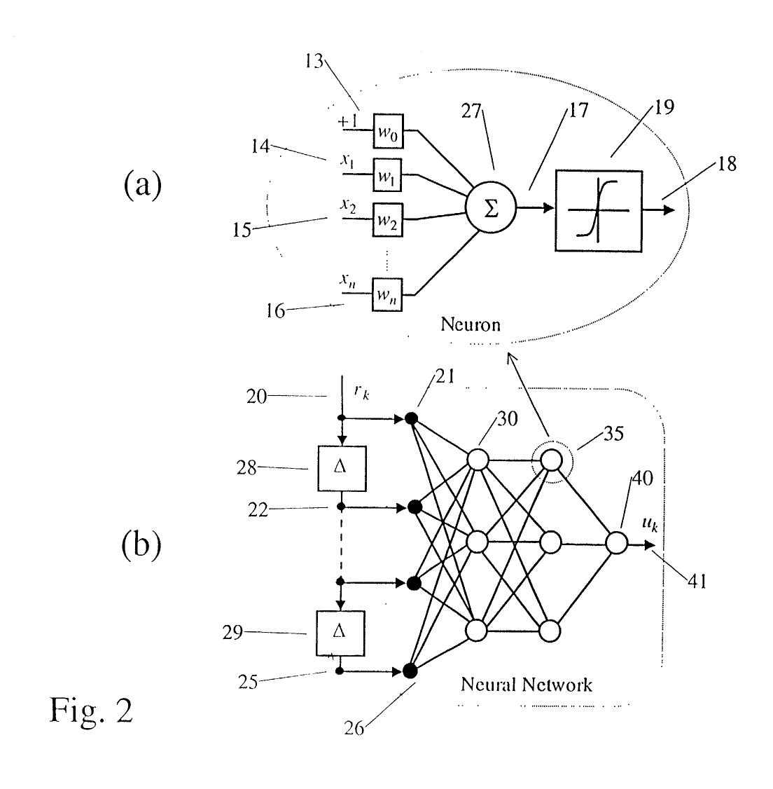

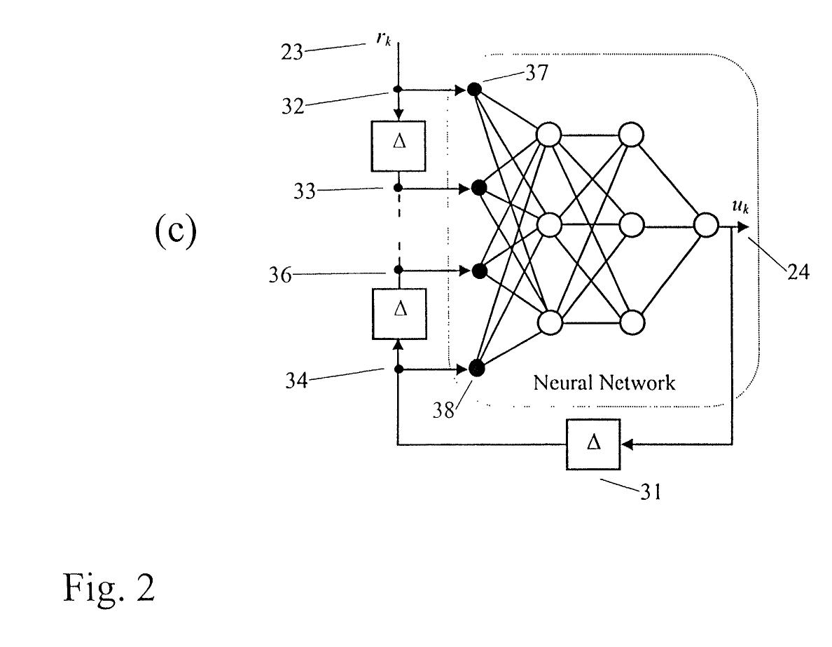

Referring to FIG. 1, a cascade of a Neurointerface 8 driving a plant 9 to be controlled is shown. The Neurointerface is designed to operate in real time. It is trained off-line, before being used to control the plant. The configuration of the Neurointerface in the form of a nonlinear adaptive filter is shown in FIG. 2. A method for training the Neurointerface is provided below.

The Neurointerface is generally trained to be an inverse of the plant or a closely approximating inverse. The input 10 to the Neurointerface is the “command input” and this comes from the human operator 7. The output response 12 of the plant 9 is very similar to the command input 10. Thus, the complex dynamics of the plant is factored out, making it easy for the operator to control it.

The topology of simple forms of Neurointerfaces is shown in FIG. 2. FIG. 2 (a) shows the basic neural element used in neurointerfaces. FIG. 2 (b) shows a Neurointerface which is a feedforward nonlinear adaptive filter consisting of a tapped delay line connected to a multilayer neural network. FIG. 2 (c) shows a Neurointerface which is a recursive nonlinear adaptive filter having feedforward and feedback parts.

The basic neuron of FIG. 2 (a) has inputs 13, 14, 15, . . . which are weighted (multiplied by coefficients w₀, w₁, . . . , wₙ), summed by summer 27, providing a weighted sum 17 that drives a nonlinear “sigmoid” function 19 providing output 18.

The Neurointerface filter shown in FIG. 2 (b) has input 20 that drives the tapped delay line. Delays are 28, 29. Signals at taps of the delay line are fed to input terminals such as 21, 26 of the neural network. Neuron 30 is one of the neurons of the first layer. Neuron 35 is a neuron of the second layer. Neuron 40 is a neuron of the output layer. The output signal is 41. This network of neurons could have two or more layers, and does not even need to be organized in layers. How the weights of the neurons of the neural network are trained is described below.

The Neurointerface filter shown in FIG. 2 (c) has two tapped delay lines, one fed by the filter input 23 and the other fed by the filter output 24 through a unit delay 31. Signals at taps of the feedforward delay line 32, 33, and signals at taps of the feedback delay line 34, 36 are fed to input terminals such as 37, 38 of the neural network.

The number of delays and taps, the number of layers of the neural network, and the number of neurons per layer are design parameters to be chosen based on the complexity of the plant to be controlled. These choices are generally not critical because of the adaptability of the network, and are usually made on an empirical basis. A Neurointerface that was used to successfully control a truck and two trailers while backing contained a tapped delay line with 39 delays, 40 taps, and a two-layer neural network with 8 neurons in the first layer and 1 neuron in the second or output layer.

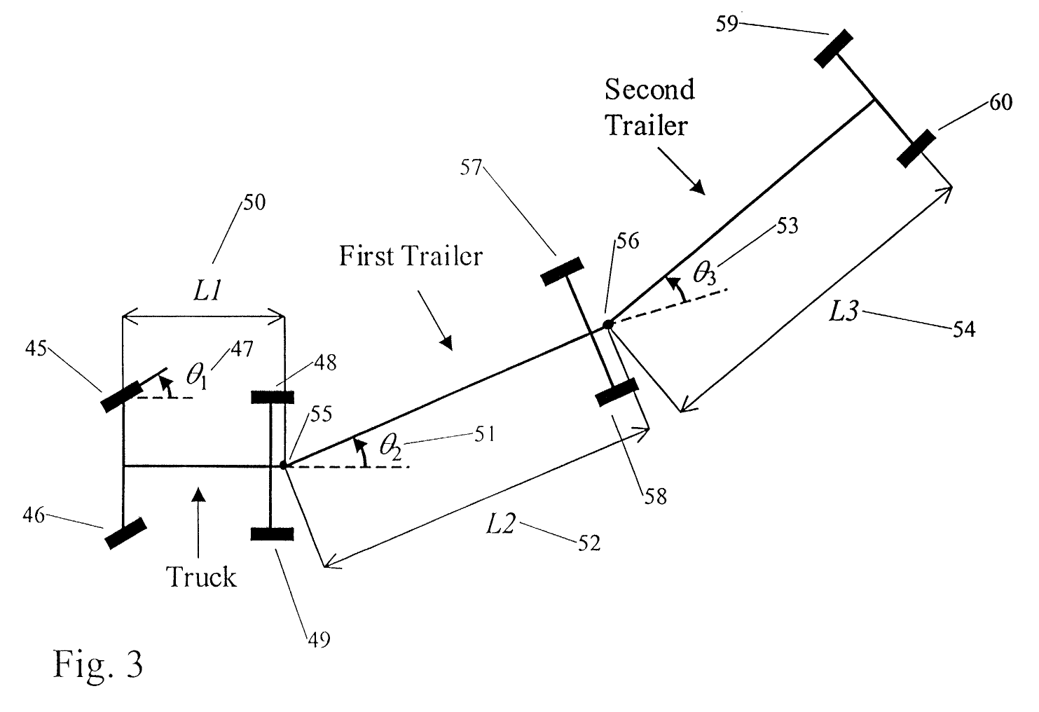

FIG. 3 shows a schematic diagram of a truck and two trailers. The kinematic equations for the motion of the truck and double trailers are easily derived from geometric considerations. Regarding the schematic diagram of the truck and trailers shown in FIG. 3, these equations are

$$\frac{\partial {θ}_{2}}{\partial t} = v ( \frac{sin {θ}_{2}}{L2} + \frac{tan {θ}_{1}}{L1} ) \\ \frac{\partial {θ}_{3}}{\partial t} = v ( - \frac{sin {θ}_{2}}{L2} + \frac{cos {θ}_{2} sin {θ}_{3}}{L3} ) , \qquad ( 1 )$$

where v is the backing speed of the truck and L1, L2 and L3 are, respectively, 50, 52, and 54, which are the effective lengths of the truck, the first, and the second trailers. θ₁ is 47, θ₂ is 51, and θ₃ is 53.

The truck backing problem involves the control of a nonlinear unstable system. The goal is to control nonlinear unstable systems under human direction. The backing truck and trailers is a good example of this.

In this work, characteristics of the plant to be controlled are assumed to be known. If this is not the case, the plant characteristics can be found by a plant identification process. This process is based on nonlinear adaptive filters like that of the Neurointerface. Methods for plant identification or plant modeling are taught in the book by Widrow and Walach [5], for example, Chapter 10, pp 274-285, Chapter 11, pp 307-311, Appendix B, pp 349-362, and Appendix H, pp 475-494.

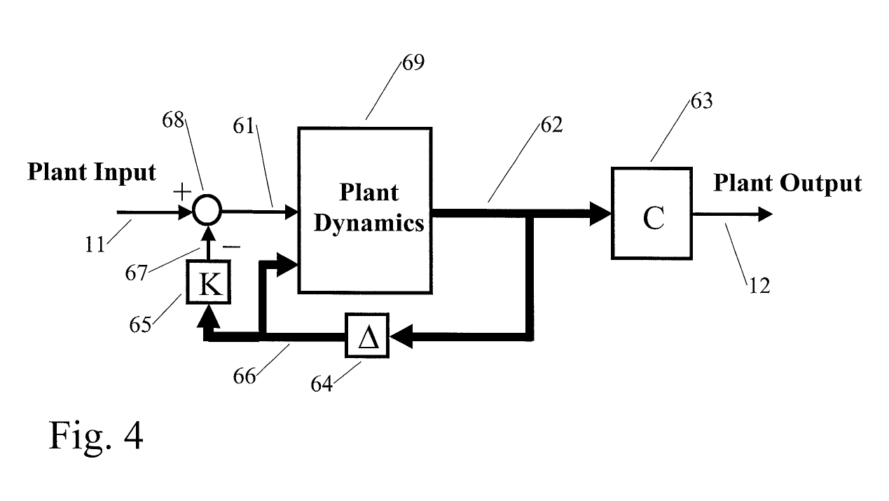

The first step is to stabilize the unstable system plant about an equilibrium point, and this can be done in many cases by making use of negative feedback with fixed gains. The idea is illustrated in FIG. 4.

In FIG. 4, the plant is represented in state space form. The plant input is 11. The plant output is 12. The heavy lines carry the state variables as vector signals. The box C, 63 is a linear combiner with fixed weights that converts the plant state variables 62 into the plant output 12. The box K, 65 is another linear combiner with fixed weights that converts the state variables into a stabilizing feedback signal 67. For the truck backer example, the state variables are θ₂, 51 and θ₃, 53. The plant output variable to be controlled is simply θ₃. The plant input is the output 11 of the Neurointerface 8.

The input command 10 to the Neurointerface 8 controls the trajectory of the truck and trailers. A constant input command causes the truck and trailers to back along a circle of fixed radius. A sudden step change of the input command causes the truck and trailers to back along a circle of a different fixed radius, after a transient takes place and dies out. A zero command input causes the truck and trailers to back along a straight line, after the transient dies out.

For the truck backer, controlling angle θ₃, 53, the angle between the two trailers, would be sufficient to control the trajectory. If the angle θ₁, 47 of the truck front wheels is controlled to achieve and maintain the correct fixed value of θ₃, the desired motion along a circle of fixed radius would occur, after transients die out. If there were more than two trailers, controlling the angle between the last two trailers would be sufficient to control the curvature of the trajectory of the entire system.

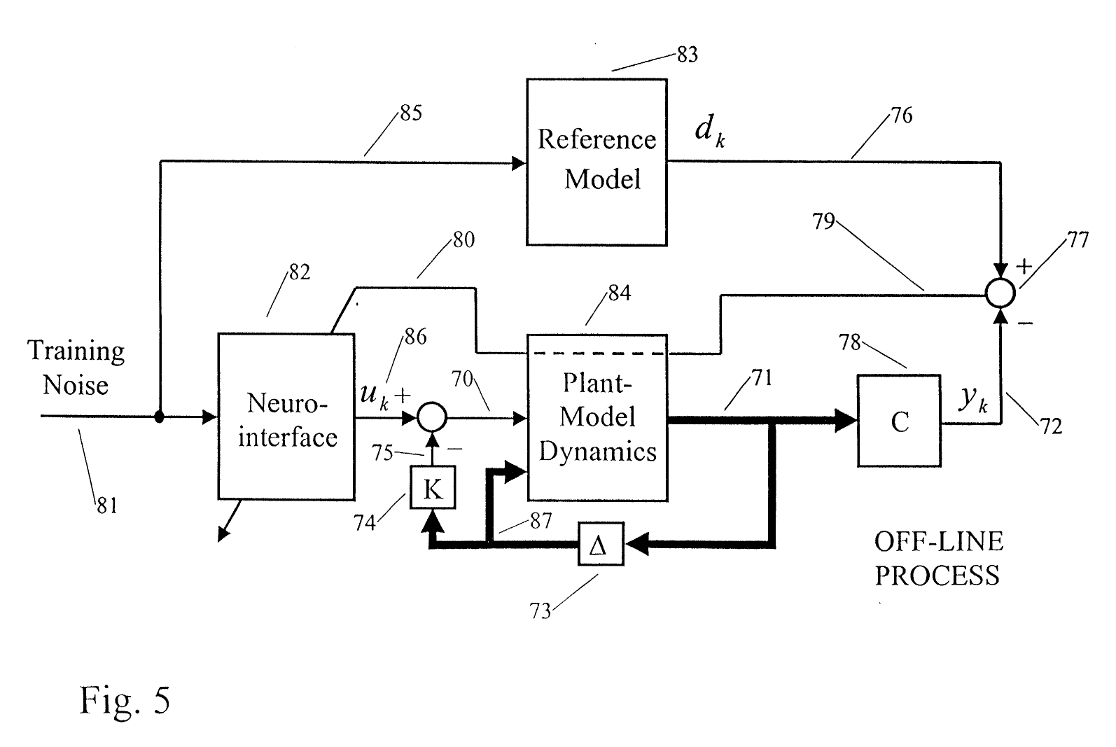

A block diagram illustrating the training of the Neurointerface is shown in FIG. 5. The Neurointerface 82 is adapted so that the cascade of it and an exact model of the plant (consisting of the plant model dynamics 84, the state feedback 87, and the stabilization feedback 75) would have the same overall response 72 as a chosen reference model 83. The Neurointerface would develop into an inverse of the plant if the reference model were a unit gain. If there is a response delay in the plant, the reference model would need the same delay or more. The reference model could be a linear system having a simple two-pole response. A reference model with a double pole has been used with the truck backer, giving an overall system response of exponential transients resulting from step changes in the input command signal. The system designer chooses a reference model to give the system a desired overall response.

Training the Neurointerface 82 is done off line. A noise input 81 to the Neurointerface is used in the training process. This noise signal is also used to drive the input of the reference model 83. The output of the reference model is compared with the plant output 72, and the difference is an error signal 79 that is to be minimized by adjusting the weights of the neural network in the Neurointerface 82. The structure of the Neurointerface is shown in FIG. 2. The Neurointerface of either FIG. 2 (b) or FIG. 2 (c) could be used.

In order to adapt the weights of the Neurointerface, an error signal at the Neurointerface output is needed. What is available however is the error signal 79 at the output of the plant model. In order to get the appropriate error signal for adapting the Neurointerface, it is necessary to “backpropagate” the available error signal through the known equations of the plant model. The basic ideas are explained in a Prentice-Hall book “Adaptive Inverse Control” by Widrow and Walach [5], pages 480-484. The specific details of how this is done are given here for a single-input single-output (SISO) Neurointerface of the type shown in FIG. 2 (b). This same procedure can be used for multiple-input multiple-output (MIMO) Neurointerfaces, and for Neurointerfaces of the type shown in FIG. 2 (c).

The nonlinear plant of FIG. 5 which is to be controlled by the Neurointerface is described by the following discrete-time state space equations

xₖ=f(xₖ₋₁,uₖ−K^{T}xₖ₋₁), (2)

yₖ=C^{T}xₖ.

Vector xₖεRⁿ^{_{τ}} represents the state variables 71, uₖεR is the plant input 86, and yₖ is the plant output 72. The variable k is the time index. Function f: Rⁿ^{ₓ}×R→Rⁿ^{_{τ}} is assumed to be analytic and f(0,0)=0. The plant is considered to be Lagrangian stable (bounded states). If this is not the case, the feedback gain KεRⁿ^{_{K}} makes the plant Lagrangian stable in an open bounded region containing the origins of the state space and plant input.

The Neurointerface is described by the equation

uₖ=g(Rₖ,w), (3)

where Rₖ=[rₖ rₖ₋₁ . . . rₖ₋ₙ_{_{R}}₊₁]^{T}εRⁿ^{_{R}}.

Signal rₖεR is the Neurointerface command input 81, and signal uₖεR, the Neurointerface output 86. Vector wεRⁿ^{ₕ} represents the weights of the feedforward neural network. The components of the vector Rₖ represent the signals 20, 22, 25 generated by the Neurointerface's tapped delay line in FIG. 2 (b). They are connected to the feedforward neural network inputs such as 21, 26 in FIG. 2 (b).

During the training phase, the Neurointerface output, uₖ, is connected directly to the plant model input 86 (also denoted by uₖ), and the goal is to adapt the weight vector w step-by-step so the mean-square error,

$$\hat{J} = \frac{1}{κ} {\sum }_{k = τ + 1}^{τ + κ} {e}_{k}^{2} Δ {e}_{k} = {d}_{k} - {y}_{k} \qquad ( 4 )$$

defined in a time window of κ samples, is reduced. The signal dₖ is the reference model output 76, and is the desired signal that the plant output yₖ is suppose to follow at each time k. The following constrained optimization problem reflects this idea:

minimize Ĵ (5)

subject to equations 2 and 3

for k=τ+1, . . . κ+τ, and x_{τ} specified.

Using Lagrangian multipliers, equation 0 can be represented as an unconstrained optimization problem in the form,

$$\begin{matrix}J = \frac{1}{κ} {\sum }_{k = τ + 1}^{τ + κ} {e}_{k}^{2} + {\sum }_{k = τ + 1}^{τ + κ} {β}_{k} ( {μ}_{k} - g ( {R}_{k} , w ) ) + \\ {\sum }_{k = τ + 1}^{τ + κ} {λ}_{k}^{T} ( {x}_{k} - f ( {x}_{k - 1} , {u}_{k} - {K}^{T} {x}_{k - 1} ) ) + \\ {\sum }_{k = τ + 1}^{τ + κ} {δ}_{k} ( {y}_{k} - {C}^{T} {x}_{k} ) ,\end{matrix} \qquad ( 6 )$$

and the objective is to calculate the gradient

$$\frac{\partial J}{\partial w}$$

so w can be adjusted using a small step Δw in the direction of

$$- \frac{\partial J}{\partial w} .$$

This will reduce the value of the mean-square error defined in equation 4. The optimization variables are now the Lagrangian multipliers βₖ,δₖεR and λₖεRⁿ^{_{τ}}, the state variables xₖ, the plant input uₖ, the plant output yₖ, and the weight vector w.

The gradient

$$\frac{\partial J}{\partial w}$$

is given by

$$\frac{\partial J}{\partial w} = - {\sum }_{k = τ + 1}^{τ + κ} {β}_{k} \frac{\partial g ( {R}_{k} , w )}{\partial w} \qquad ( 7 )$$

In order to compute it, one must calculate the values of βₖ, for k=τ+1, . . . , τ+κ. They are obtained by applying the optimality conditions,

$$\frac{\partial J}{\partial {β}_{k}} = \frac{\partial J}{\partial {δ}_{k}} = \frac{\partial J}{\partial {λ}_{k}} = \frac{\partial J}{\partial {x}_{k}} = \frac{\partial J}{\partial {u}_{k}} = \frac{\partial J}{\partial {y}_{k}} = 0 , \qquad ( 8 )$$

to equation 6. As a result, the plant model equations need to be computed for κ samples of the time window. They are:

uₖ=g(Rₖ,w),

xₖ=f(xₖ₋₁,uₖ−K^{T}xₖ₋₁), (9)

yₖ=C^{T}xₖ

k=τ+1, . . . , τ+κ, and x_{τ} specified.

Likewise, the Lagrangian variables are also computed in the same time window. First, δₖ is computed using the error signal eₖ and the following equation:

$${δ}_{k} = \frac{2}{κ} {e}_{k} , k = τ + 1 , … , κ + τ \qquad ( 10 )$$

Second, λₖ is computed through a recursive equation running backwards in time:

$${λ}_{k} = {( \frac{\partial f ( {x}_{k} , {u}_{k} - {K}^{T} {x}_{k} )}{\partial {x}_{k}} )}^{T} {λ}_{k + 1} + {δ}_{k} C , \\ for k = κ + τ - 1 , … , τ + 1 and {λ}_{κ + τ} = {δ}_{κ + τ} C \qquad ( 11 )$$

Finally, the values of βhd k, k=τ+1, . . . , τ+κ are computed through the following equation:

$${β}_{k} = {λ}_{k}^{T} ( \frac{\partial f ( {x}_{k - 1} , {u}_{k} - {K}^{T} {x}_{k - 1} )}{\partial {u}_{k}} ) , \qquad ( 12 )$$

With these values, it is possible to compute the gradient

$$\frac{\partial J}{\partial w}$$

using equation 7. The Lagrangian multiplier βₖ is the “error” signal referred to the output of the Neurointerface, needed to adapt it.

The following algorithm summarizes the steps necessary to compute the gradient

$$\frac{\partial J}{\partial w} .$$

Algorithm 1: Given Rₖ and dₖ for k=τ+1, . . . , τ+κ; given x_{τ} and w;

1. for k=τ+1, . . . , τ+κ, compute:

$${u}_{k} = g ( {R}_{k} , w )$$

$${x}_{k} = f ( {x}_{k - 1} , {u}_{k} - {K}^{T} {x}_{k - 1} )$$

$${y}_{k} = {C}^{T} {x}_{k}$$

$${δ}_{k} = \frac{2}{κ} {e}_{k}$$

2. for k=κ+τ−1, . . . , τ+1 and λ_{κ+τ}=δ_{κ+τ}C, compute:

$${λ}_{k} = {( \frac{\partial f ( {x}_{k} , {u}_{k} - {K}^{T} {x}_{k} )}{\partial {x}_{k}} )}^{T} {λ}_{k + 1} + {δ}_{k} C ,$$

3. for k=τ+1, . . . , τ+κ, compute:

$${β}_{k} = {λ}_{k}^{T} ( \frac{\partial f ( {x}_{k - 1} , {u}_{k} - {K}^{T} {x}_{k - 1} )}{\partial {u}_{k}} )$$

4. compute the gradient

$$\frac{\partial J}{\partial w} \text{:}$$

$$\frac{\partial J}{\partial w} = - {\sum }_{k = τ + 1}^{τ + κ} {β}_{k} \frac{\partial g ( {R}_{k} , w )}{\partial w}$$

The gradient

$$\frac{\partial J}{\partial w}$$

is a moving average of the κ samples in the window. With its value, the weight vector w can be updated using the equation:

$$Δ w = - α \frac{\partial {J}^{T}}{\partial w} \qquad ( 13 )$$

where α is a small positive number that controls the speed of convergence of the adaptive algorithm.

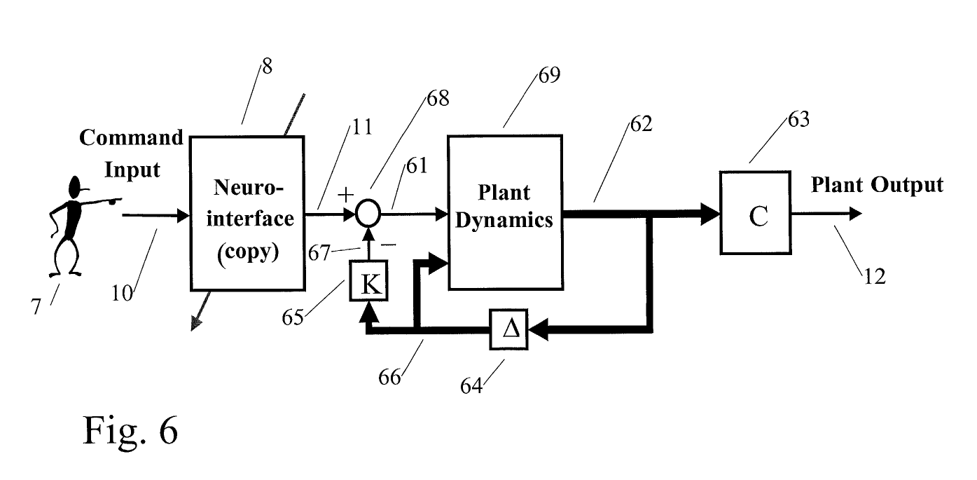

Once the Neurointerface is trained, it can be used to control the plant. Referring to FIG. 6, the human command input to the Neurointerface causes the plant output to respond as if the cascade of Neurointerface 8 and plant were equivalent to the reference model 83.

An important subject is that of plant disturbance. The configuration of Neurointerface and plant of FIG. 1 does not consider or show this. In fact, if plant disturbance were present, it would be apparent to the human operator who in some cases might be able to modify the command input in order to counteract the disturbance. Generally, this would not be easy for the operator to do because of the effects of inherent delay in the overall plant dynamic response. Some other means for dealing with plant disturbance without requiring action on the part of the human operator would be desirable.

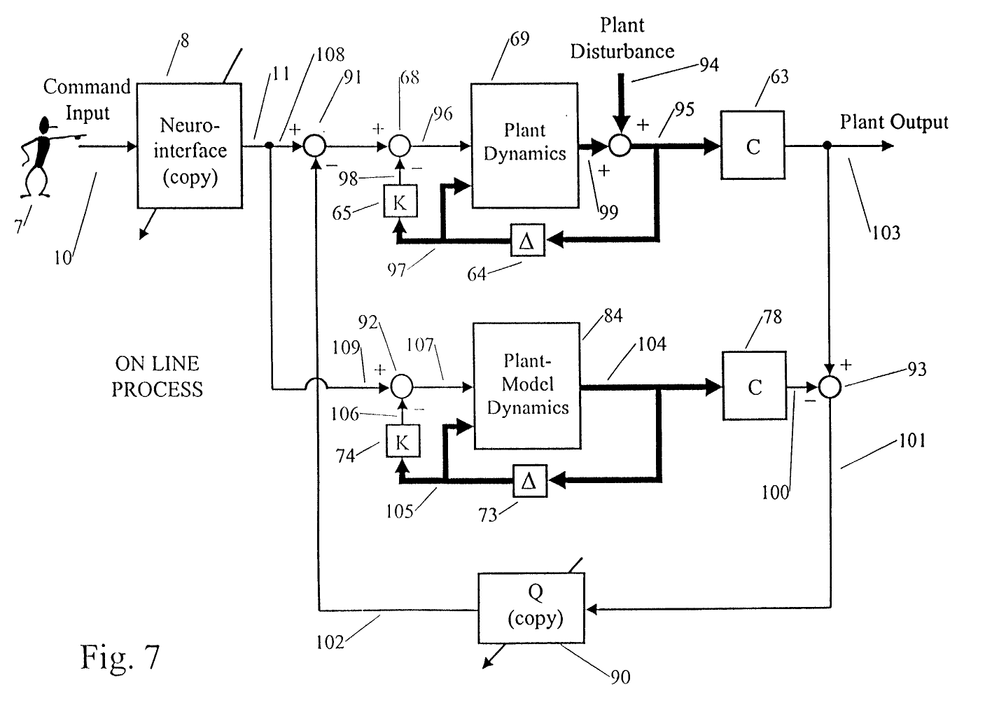

A method for canceling plant disturbance without affecting the plant dynamics is taught in Chapter 8 of the 1998 Prentice-Hall book by Widrow and Walach [5]. The method can be applied to Neurointerface control. The idea is illustrated by the block diagram of FIG. 7. The following is a brief explanation. A full description is given in the reference.

Refer now to FIG. 7. It can be seen that once again a copy of the Neurointerface 8 is used to drive the plant. This diagram is more complicated than that of FIG. 6 however because it includes an adaptive disturbance canceller.

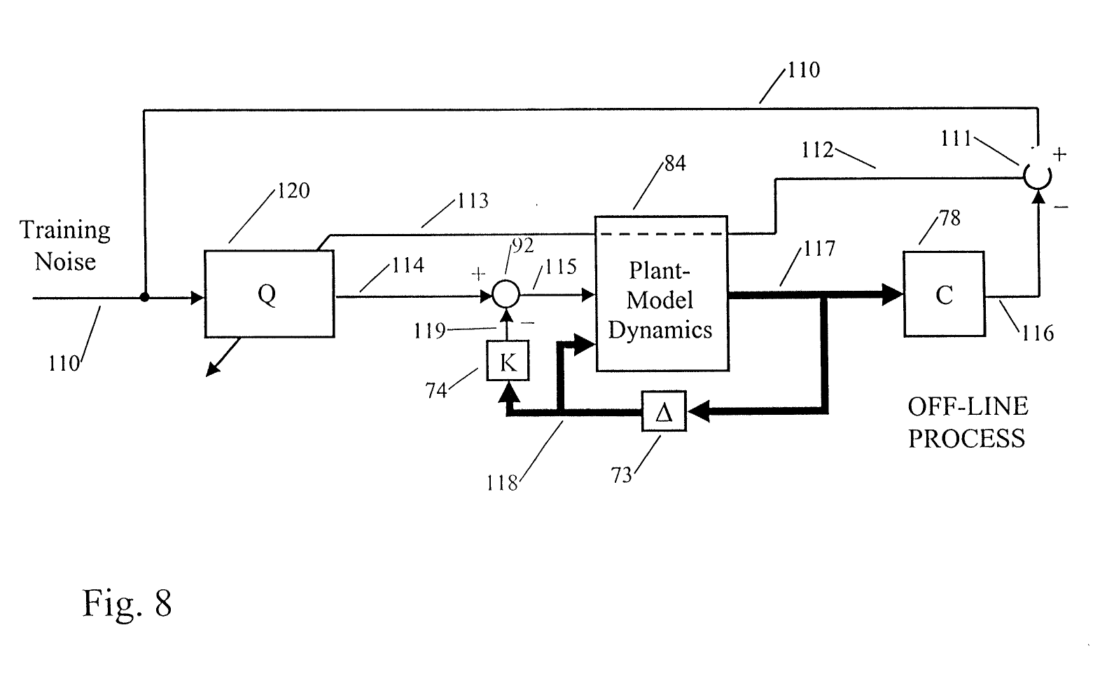

In FIG. 7, both the plant and an exact model of the plant are driven by the Neurointerface output 11. The output of the plant model 100, which is disturbance free, is subtracted from the plant output 103. The difference is the plant disturbance 101, referred to the plant output. The plant disturbance is fed to the box labeled Q (copy) 90. This box is a nonlinear adaptive filter that has been trained by a off line process (see FIG. 8) to be a best least squares inverse of the plant. The output 102 of Q is subtracted from the plant input 108, but not subtracted from the plant model input 109. It is shown in the Widrow, Walach reference [5] that if the plant is linear, this feedback noise canceller is optimal, and that it reduces the plant disturbance observed at the plant output to the lowest level physically possible in the least squares sense. This optimality has not been proven yet for nonlinear systems, but simulation experiments have shown the adaptive canceller to be highly effective. In any event, because the driven response of the plant and the plant model are identical, subtracting their outputs to obtain the disturbance signal to drive Q and to obtain disturbance canceling feedback results in a feedback loop with zero gain around it. Thus, the disturbance canceller does not affect the dynamic response of the plant, whether the plant is linear or nonlinear. The training of the box Q, 120, shown in FIG. 8, uses a random wideband training-noise signal 110 to effect a learning process that makes the cascade of Q and the plant model behave as best possible in the least square sense like a piece of wire, i.e. like a unit gain. The training process is identical to that used in FIG. 5 to train the Neurointerface. Both the filter Q and the Neurointerface are configured like the nonlinear adaptive filter shown in FIG. 2.

If the filter Q is an exact inverse of the plant, then the plant disturbance will be perfectly cancelled. This will never happen perfectly however, because there must always be at least one sample time of delay around the loop. Also, any delay in the plant will prevent Q from being a perfect inverse of the plant. In the linear case, if the plant is nonminimum phase, Q cannot be a perfect inverse, but the adaptive disturbance canceller is nevertheless optimal. In the nonlinear case, optimality is plausible.

These disturbance-canceling techniques can be used with both SISO and MIMO plants.

Application of Neurointerface control has been made to the truck backer. This was done two ways, by computer simulation and with an actual scale-model truck and trailer that is approximately 1.5 meters long.

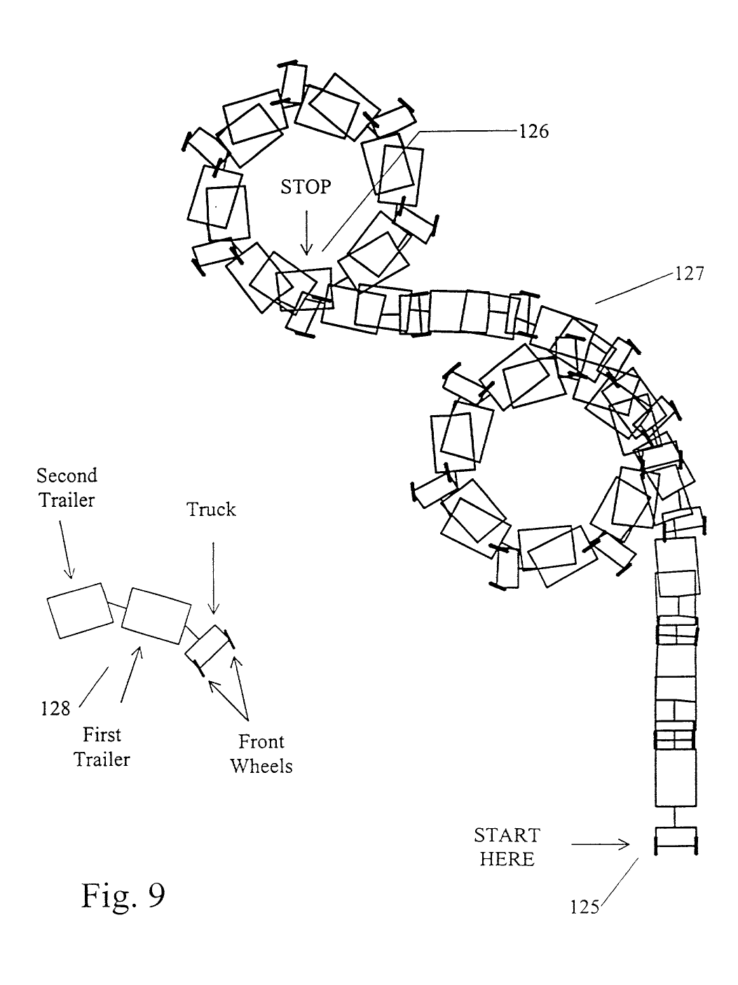

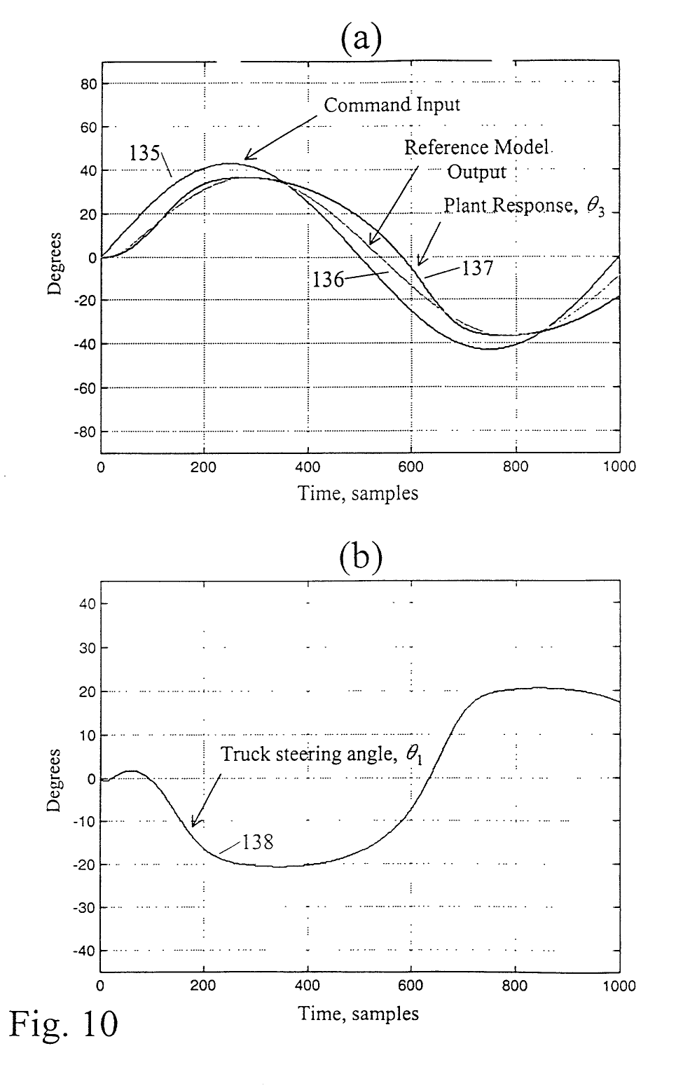

The results of a typical computer simulation experiment are shown in FIGS. 9 and 10. In FIG. 9, the backing trajectory 127 of the truck and two trailers is shown. This trajectory results from application of a sinusoidal command input, plot 135 in FIG. 10 (a). The command input exercises control over the plant variable θ₃. This is the plant output, and it is plot 137 in FIG. 10 (a). The motion of θ₃ versus time should match the response of the reference model if it too were driven by the command input. This response has been computed, and it is shown as plot 136 in FIG. 10 (a). These plots are quite similar. This indicates that the nonlinear Neurointerface, trained by the scheme of FIG. 5 (in accord with Algorithm 1 and equation 13), when cascaded with the nonlinear plant model of FIG. 5, has a response 137 that very well matches that of the linear reference model 136.

The truck steering angle versus time is shown as plot 138 in FIG. 10 (b). This strange steering function caused the desired backing trajectory of FIG. 9 and the appropriate angle θ₃ response plotted in FIG. 10 (a). It is small wonder that a human driver can not back up a tandem, a truck and two trailers.

In this simulation, the total length of the truck and trailers was 1.5 meters, and the truck was backing at a constant speed of 1 meter per second. The sampling rate for the simulation was 50 samples per second. For the off-line computations to obtain the Neurointerface and the filter Q, the moving average window in each case contained κ=10 samples.

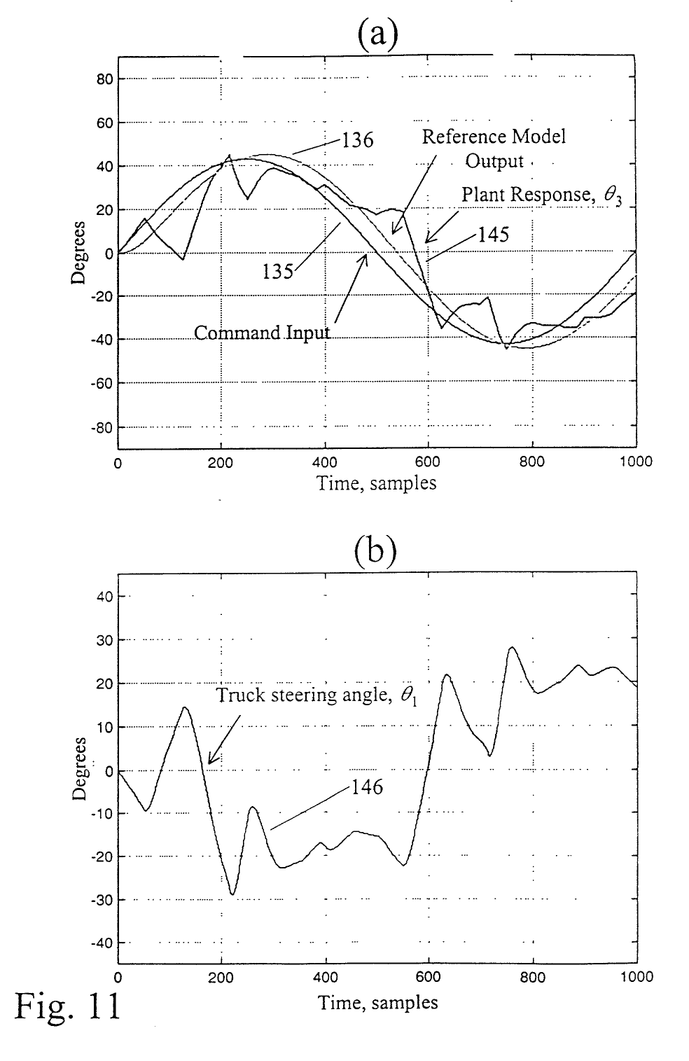

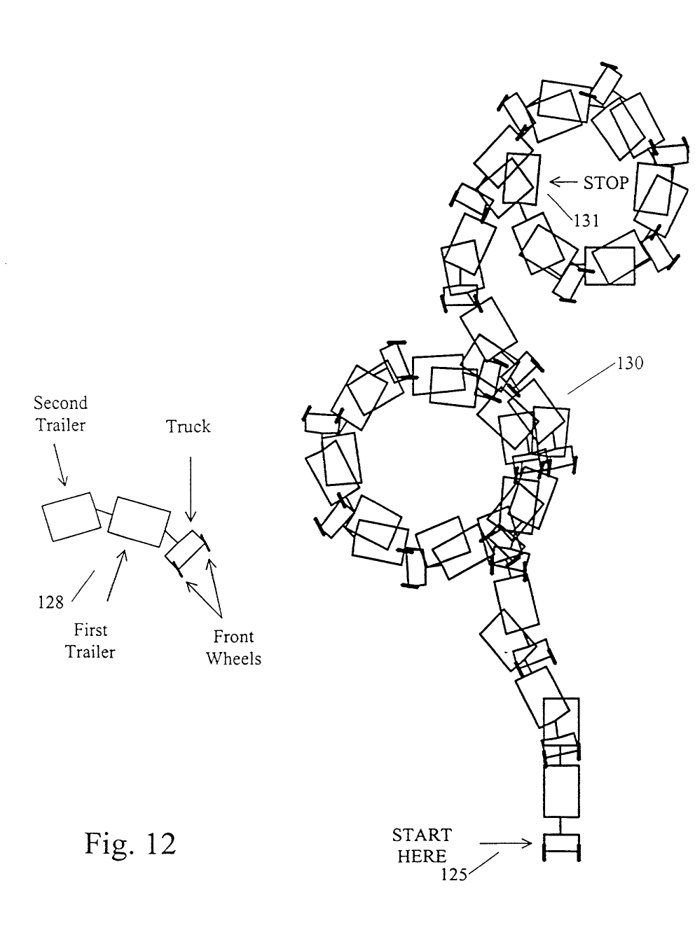

In the above described experiment, there was no plant disturbance. The same experiment was repeated with a violent plant disturbance to test the disturbance canceller of FIG. 7. The command input 135, the plant response 145, and the computed response 136 of the reference model are plotted in FIG. 11 (a). The truck steering angle 146 is plotted versus time in FIG. 11 (b). The jitter in steering angle which was needed to compensate for the plant disturbance is very evident. In spite of the disturbance, the system remains stable and does not jackknife. The backing trajectory is shown in FIG. 12. The disturbance has caused the truck to take a somewhat different course. A human controlling the truck could have kept the truck on course, if he wished, compensating for the positional drift without needing to worry about jackknifing.

Experiments with the scale-model truck under human steering command have been done. Instead of a computer generated sinusoidal command input, manual steering commands have been inputted to the Neurointerface by means of a small steering wheel connected to a radio transmitter. The received command input was fed to a Neurointerface implemented by an Intel 486 battery-operated computer. The QNX® real-time operating system was used by the 486 computer. All programming was done in the C language. The output of the Neurointerface drove a servo that controlled the steering angle θ₁ of the truck. Operation of the scale-model truck and trailers worked like the computer simulation. It was easy to steer the truck and two trailers, even while backing at high speed.

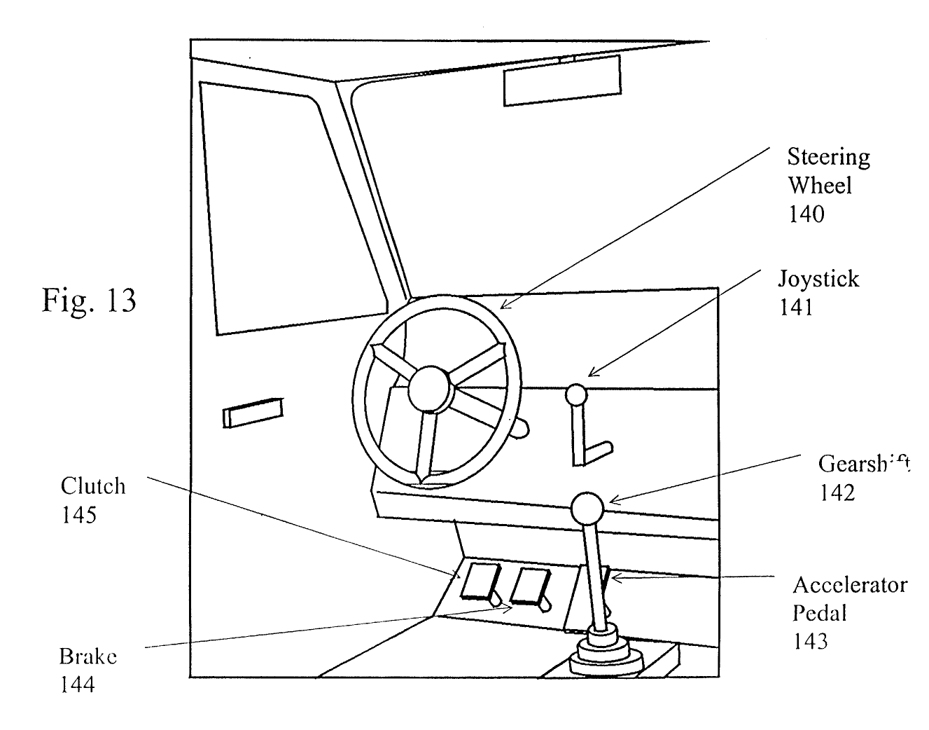

FIG. 13 shows the control in the cab of a large trailer-truck, with a Neurointerface installed for backing one or more trailers. The steering wheel 140, the clutch 145, the brake pedal 144, the accelerator pedal 143, and the gearshift 142 are conventional. The operation of the truck going forward is conventional. For backing, steering is done with the Neurointerface controlled by a joystick 141 that may be mounted conveniently on the dashboard or close thereto. While backing, the driver operates the joystick, pushing it left or right, providing the command input. Pushing it left makes the rear of the farthest away trailer curve left, pushing it right makes the rear of the farthest away trailer curve right. The steering wheel and steering column will be turning under the control of the Neurointerface. The driver should keep his hand on the joystick, and keep hands off the steering wheel when backing with the Neurointerface.

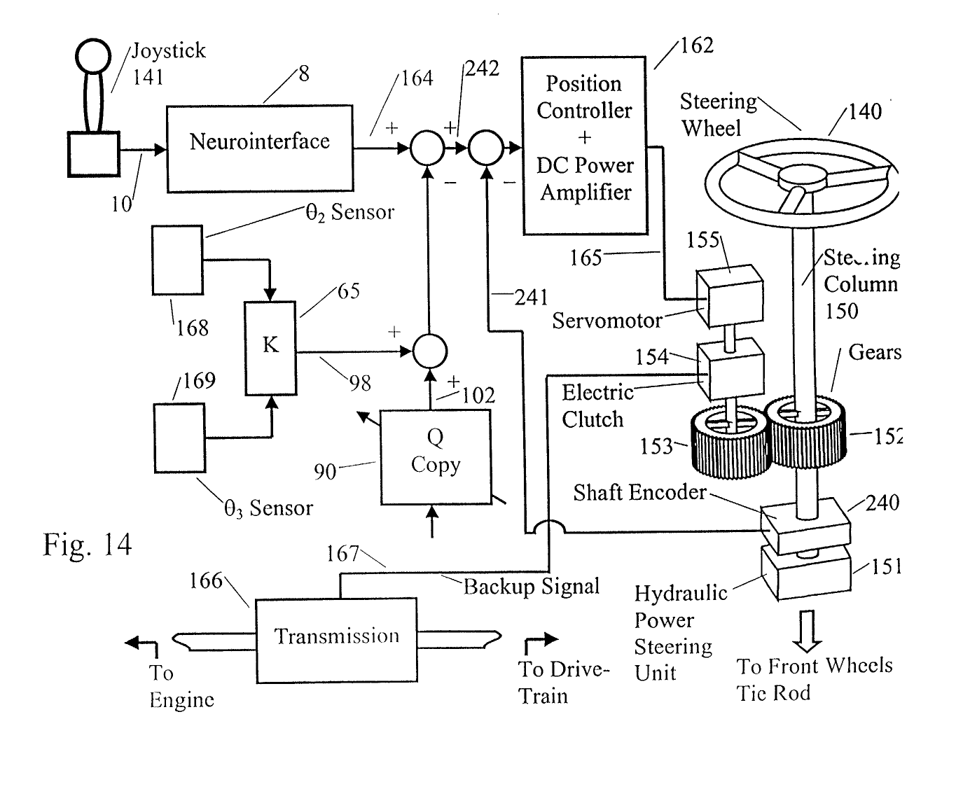

FIG. 14 shows in detail how the joystick and Neurointerface are coupled to the steering gear of the truck. The joystick 141 provides an electrical output signal responsive to left or right positioning of the joystick handle. This electrical signal is the command input signal 10 to the Neurointerface 8. The Neurointerface is designed and trained in accord with the previous teaching. The output 164 of the Neurointerface drives the plant. The complete system is built in according to the schematic diagram of FIG. 7.

In accord with FIGS. 7 and 14, the stabilization feedback signal 98 and the disturbance canceling signal 102 are subtracted from the Neurointerface output 164. The stabilization feedback signal is a weighted sum of the two state variables, θ₂ and θ₃. The sensor 168 of state variable θ₂ and the sensor 169 of state variable θ₃, both defined in the schematic diagram of FIG. 3, provide proportional electrical output signals that are linearly weighted in the box K, 65, to provide the stabilization signal 98. The box Q copy, part of the disturbance canceling system is trained by the method illustrated in FIG. 8. The plant output signal 103 is the state variable θ₃. This is the variable controlled by the system. The sensors that measure angles θ₂ and θ₃ could be optical, acoustic, resistive (potentiometer), or based on some other principle.

Referring again to FIG. 14, the Neurointerface minus the stabilizing signal 98 and minus the disturbance canceling signal 102 drives a conventional position controller with a DC output amplifier 162 whose output drives a servomotor 155. The angular output of the servomotor couples through an electric clutch 154 and gears 153 and 152 to the steering column. A shaft encoder 240 on the steering column provides a feedback signal to the position controller allowing the steering angle control signal 242 to determine the angular position of the truck front wheels, the angle, 47. When the clutch is electrically activated, the Neurointerface system controls the steering column. This only can happen when the transmission 166 is shifted into reverse, activating the backup signal 167 (normally used to provide a warning alarm that the truck is backing) which in turn activates the clutch 154. Otherwise, the clutch is disengaged when the truck is going forward and the Neurointerface is disconnected. Thus, steering is normal in the forward direction. This is important for driving safety.

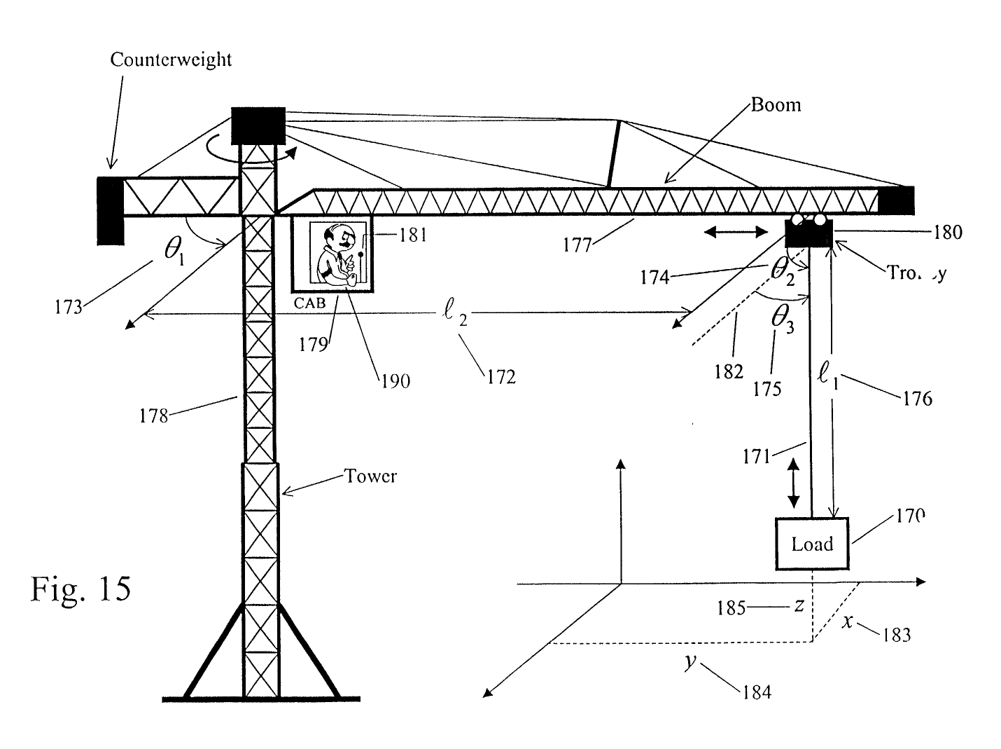

Another application of the Neurointerface is to human control of a large construction crane. A Fixed tower crane is shown in FIG. 15. The tower 178 supports the boom 177 which in turn supports the trolley 180. A steel cable 171 drops from the trolley to the load 170. The operator 190 in the cab 179 observes the load and controls its position in three-dimensional space by means of a three-dimensional joystick 181. The operator can move the joystick handle left or right, and fore or aft, and up or down. The joystick controls the velocity of the load movements. If the operator takes his hand off the joystick, internal springs will return it to its neutral position and the load will remain in fixed position in three-dimensional space. If the joystick is pushed forward, the load moves forward with a velocity proportional to the joystick displacement. Similar movements of the load take place in response to joystick displacements along its other directions.

The Neurointerface and the plant being controlled are MIMO systems in this case. The input command from the joystick that drives the Neurointerface is three-dimensional. The output response of the plant, the time derivative of the position of the load x, y, z (velocity) is also three dimensional.

When controlling the speed of the load, the variables that are controlled are the distance l₂ 172 of the trolley from the tower, the angle θ₁ 173 of the boom, and the length l₁ 176 of the steel cable from the trolley to the load.

Two of the state variables are θ₂ 174 and its time derivative,

$$\frac{\partial {θ}_{2}}{\partial t} ,$$

θ₂ being the angle between the steel cable 171 and the boom 177 in the plane of the tower and the boom. Two more state variables are θ₃ and its time derivative

$$\frac{\partial {θ}_{3}}{\partial t} ,$$

θ₃ being the angle between the steel cable 171 and an imaginary horizontal line 182 perpendicular to the boom. Sensors are needed to obtain signals proportional to θ₂ and θ₃. The derivatives may be obtained by electronic differentiation.

If the operator 190 were directly controlling the three variables l₁, l₂, and θ₁, it would be very difficult to change the position of the load without oscillation, without it swinging to and fro at the end of the steel cable. Using the Neurointerface with inputs from the joystick, it is quite easy for the operator to precisely position the load in three-dimensional space and to change its position over time without oscillation.

An entire control system for the construction crane is the one shown in FIG. 7. The output of Neurointerface 8 is 11, and this consists of the three variables to be controlled, l₁, 176, l₂, 172, and θ₁, 173. The output of the plant is 103, and this is the time derivatives of x, 183, y, 184, and z, 185. The plant state vector 95 is θ₂ 174, θ₃ 175, and their time derivatives

$$\frac{\partial {θ}_{2}}{\partial t} and \frac{\partial {θ}_{3}}{\partial t} .$$

The plant is undamped, making it marginally unstable. To dampen it and make it stable, the state variables are fed to the linear combiner box K 65 whose output is fed back to the plant input.

Disturbance to the load positioning system could come from wind blowing on the load. The disturbance canceller should be included to combat this.

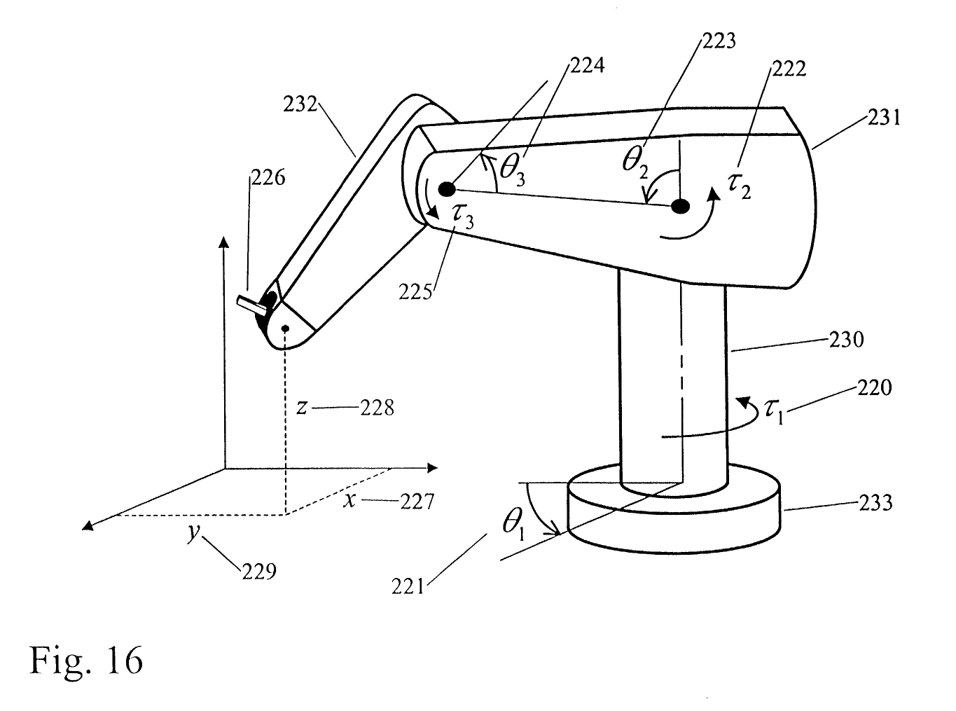

A further application of the Neurointerface is to human control of a robot arm. FIG. 16 shows a robot arm that can be controlled by an operator with a three dimensional joystick. This joystick is not spring loaded, so that when the operator's hand releases it, the joystick retains its position in three dimensions. The objective is to position the base of the robot's effector 226 so that its coordinates x, 227, y, 229, and z, 228 correspond respectively to the three dimensional positioning of the joystick. Thus, the motion of the effector will be proportional to the motion of the joystick.

Three command inputs come from the coordinates of position of the joystick. This is the input to the Neurointerface. Three outputs of the Neurointerface are sent to the robot, whose torques τ₁, 220, τ₂, 222, and τ₃, 225 will be proportional to the respective three Neurointerface output signals. These torques cause the robot arm effector to take the selected position in x, y, z-space.

An entire control system suitable for the robot arm is shown in FIG. 7. The output of Neurointerface 8 is 11, and this is proportional to the three variables τ₁, τ₂, and τ₃ to be controlled. The output of the plant is 103, and in this case that is x, 227, y, 229, and z, 228. The plant state vector 95 is θ₁, 221 and its time derivative

$$\frac{\partial {θ}_{1}}{\partial t} ,$$

θ₂, 223 and its time derivative

$$\frac{\partial {θ}_{2}}{\partial t} ,$$

and θ₃, 224 and its time derivative

$$\frac{\partial {θ}_{3}}{\partial t} .$$

The plant response contains integration, making it marginally unstable. To make it stable, the state variables are fed to the linear combiner box K, 65 whose output is fed back to the plant input in accord with the block diagram of FIG. 7. Sensors are needed to obtain signals proportional to θ₁, θ₂, and θ₃. Their derivatives may be obtained by electronic differentiation. Disturbance to the robot arm could come from variable force loading on the effector, and a disturbance canceller like that of FIGS. 7 and 8 should be included to combat this.

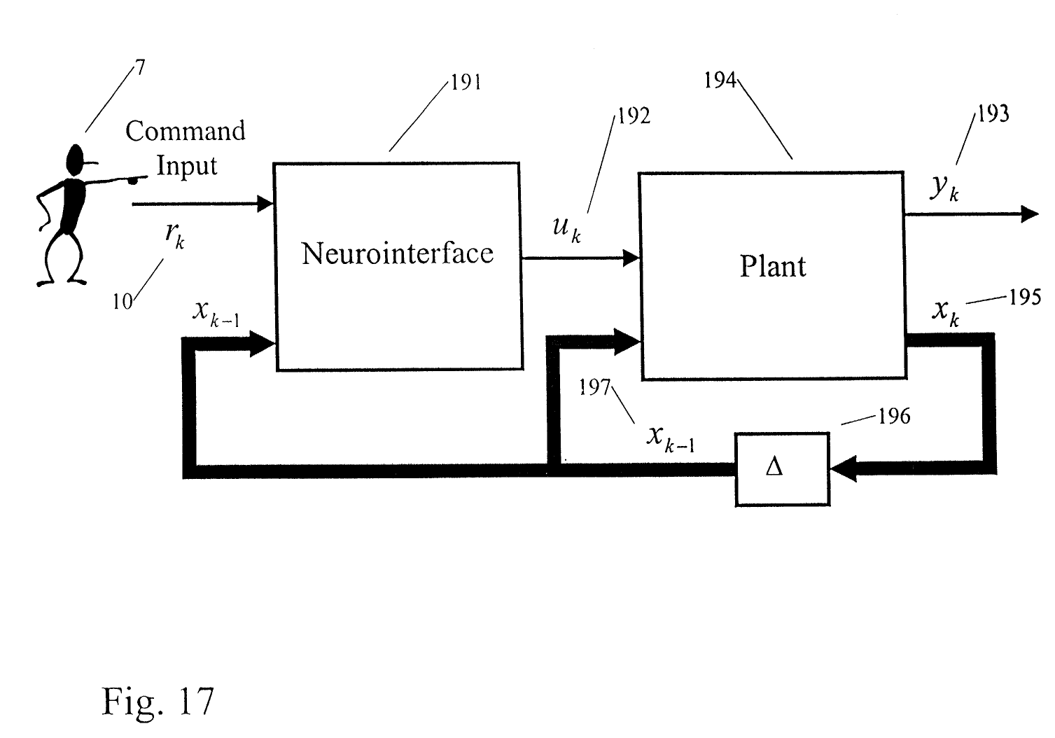

Another embodiment of the Neurointerface can be constructed in accord with the block diagram of FIG. 17. The command input is fed to the Neurointerface 191, whose output controls the plant input 192. With this embodiment, the state variables 195 are fed back to the Neurointerface. The Neurointerface contains a stabilization feedback circuit and a disturbance canceling circuit. The functioning of the system would be very similar to that of the system of FIG. 7.

The specific details of how the Neurointerface is trained, for the embodiment shown in FIG. 17, are given here. For generality, the mathematical derivations are done for MIMO systems, and indeed, the truck backer system, the construction crane, and the robot arm can all be regarded as possible applications for the general Neurointerface MIMO control system of FIG. 17.

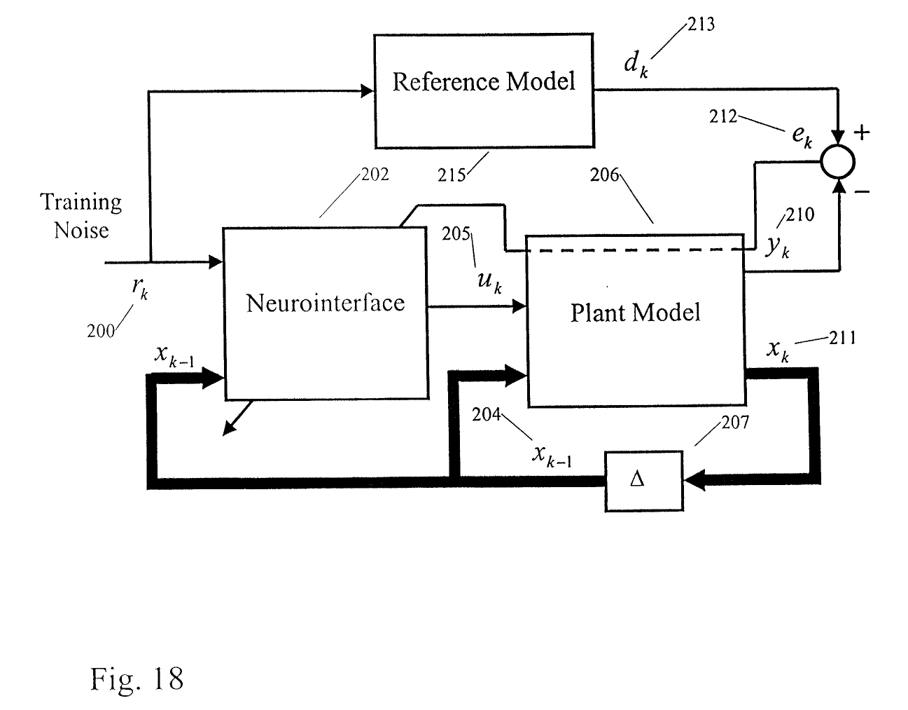

The Neurointerface in FIG. 17 is trained in accord with the diagram shown in FIG. 18. In order to adapt the weights of the Neurointerface, an error signal at the Neurointerface output is needed. What is available however is the error signal 212 at the output of the plant model. In order to get the appropriate error signal for adapting the Neurointerface, it is necessary to “backpropagate” the available error signal through the known equations of the plant model.

The nonlinear plant of FIG. 17, which is to be controlled by the Neurointerface, is represented in FIG. 18 and can be described by the following discrete-time state space model

xₖ=f(xₖ₋₁,uₖ), (14)

yₖ=h(xₖ).

Vector xₖεRⁿ^{ₓ} represents the state variables 211, uₖεRⁿ^{ᵤ} is the plant input 205, and yₖεRⁿ^{_{y}} is the plant output 210. The variable k is the time index. Functions f:Rⁿ^{_{τ}}×Rⁿ^{ᵤ}→Rⁿ^{_{τ}}and h:Rⁿ^{_{τ}}→Rⁿ^{_{y}} are assumed to be analytic. The Neurointerface is described by the equation

uₖ=g(τₖ, xₖ₋₁,w), (15)

where rₖεR^{N}^{ᵣ}, wεRⁿ^{_{w}}

Vector signal rₖ is the Neurointerface command input 200, and vector signal uₖ, the Neurointerface output 205. Vector w represents the weights of the feedforward neural network. This Neurointerface is strictly combinatorial and it has no tapped delay lines. The effect of memory comes from the state feedback instead of from tapped delay lines.

During the training phase, the Neurointerface output, uₖ, is connected to the plant model input 205 (also denoted by uₖ), and the goal is to adapt the weight vector w step-by-step so the mean-square error,

$$\hat{J} = \frac{1}{κ} {\sum }_{k = τ + 1}^{τ + κ} {e}_{k}^{T} {e}_{k} {e}_{k} = {d}_{k} - {y}_{k} \qquad ( 16 )$$

defined in a time window of κ samples, is reduced. The signal dₖεRⁿ^{_{y}} is the reference model output 213, and is the desired signal that the plant output yₖ is suppose to follow at each time k. The following constrained optimization problem reflects this idea:

minimize Ĵ (17)

subject to equations 14 and 15

for k=τ+1, . . . , κ+τ, and x_{τ} specified.

Using Lagrangian multipliers, equation 17 can be represented as an unconstrained optimization problem in the form,

$$\begin{matrix}J = \frac{1}{κ} {\sum }_{k = τ + 1}^{τ + κ} {e}_{k}^{T} {e}_{k} + {\sum }_{k = τ + 1}^{τ + κ} {β}_{k}^{T} ( {u}_{k} - g ( {r}_{k} , {x}_{k - 1} , w ) ) + \\ {\sum }_{k = τ + 1}^{τ + κ} {λ}_{k}^{T} ( {x}_{k} - f ( {x}_{k - 1} , {u}_{k} ) ) + {\sum }_{k = τ - 1}^{τ + κ} {δ}_{k}^{T} ( {y}_{k} - h ( {x}_{k} ) ) ,\end{matrix} \qquad ( 18 )$$

and the objective is to calculate the gradient

$$\frac{\partial J}{\partial w}$$

so w can be adjusted using a small step Δw in the direction of −

$$- \frac{\partial J}{\partial w} .$$

This will reduce the value of the mean-square error defined in equation 16. The optimization variables are now the Lagrangian multipliers βₖεRⁿ^{ᵤ},δₖεRⁿ^{_{y}} and λₖεRⁿ^{ₓ}, the state variables xₖ, the plant input uₖ, the plant output yₖ, and the weight vector w.

The gradient

$$\frac{\partial J}{\partial w}$$

is given by

$$\frac{\partial J}{\partial w} = - {\sum }_{k = τ + 1}^{τ + κ} {β}_{k}^{T} \frac{\partial g ( {r}_{k} , {x}_{k - 1} , w )}{\partial w} \qquad ( 19 )$$

In order to compute it, one must calculate the values of βₖ, for k=+1, . . . , τ+κ. They are obtained by applying the optimality conditions,

$$\frac{\partial J}{\partial {β}_{k}} = \frac{\partial J}{\partial {δ}_{k}} = \frac{\partial J}{\partial {λ}_{k}} = \frac{\partial J}{\partial {x}_{k}} = \frac{\partial J}{\partial {u}_{k}} = \frac{\partial J}{\partial {y}_{k}} = 0 , \qquad ( 20 )$$

to equation 18. As a result, the plant model equations need to be computed for κ samples of the time window. They are:

uₖ=g(rₖ,xₖ₋₁,w),

xₖ=f(xₖ₋₁,uₖ), (21)

yₖ=h(xₖ)

k=τ+1, . . . , τ+κ, and x_{τ} specified.

Likewise, the Lagrangian variables are also computed in the same time window. First, δₖ is computed using the error signal eₖ and the following equation:

$${δ}_{k} = \frac{2}{κ} {e}_{k} , k = τ + 1 , … , κ + τ \qquad ( 22 )$$

Second, λₖ is computed through a recursive equation running backwards in time:

$$\begin{matrix}{λ}_{k} = {( \frac{\partial f ( {x}_{k} , {u}_{k + 1} )}{{x}_{k}} + \frac{\partial f ( {x}_{k} , {u}_{k + 1} )}{\partial {u}_{k + 1}} \frac{\partial g ( {r}_{k + 1} , {x}_{k} , w )}{\partial {x}_{k}} )}^{T} {λ}_{k + 1} + \\ {( \frac{\partial h ( {x}_{k} )}{\partial {x}_{k}} )}^{T} {δ}_{k} ,\end{matrix} \\ for k = κ + τ - 1 , … , τ + 1 and {λ}_{κ + τ} = {( \frac{\partial h ( {x}_{κ + τ} )}{\partial {x}_{κ + τ}} )}^{T} {δ}_{κ + τ} \qquad ( 23 )$$

Finally, the values of βₖ, k=τ+1, . . . , τ+κ are computed through the following equation:

$${β}_{k} = {( \frac{\partial f ( {x}_{k - 1} , {u}_{k} )}{\partial {u}_{k}} )}^{T} {λ}_{k} , \qquad ( 24 )$$

With these values, it is possible to compute the gradient

$$\frac{\partial J}{\partial w}$$

using equation 19. The Lagrangian multiplier βₖ is the “error” signal referred to the output of the Neurointerface, needed to adapt it.

The following algorithm summarizes the steps necessary to compute the gradient

$$\frac{\partial J}{\partial w} .$$

Algorithm 2: Given rₖ and dₖ for k=τ+1, . . . , τ+κ; given x_{τ} and w;

$$\begin{matrix}1. for k = τ + 1 , … , τ + κ , \text{compute:} \\ \begin{matrix}{u}_{k} = g ( {r}_{k} , {x}_{k - 1} , w ) \\ {x}_{k} = f ( {x}_{k - 1} , {u}_{k} ) \\ {y}_{k} = h ( {x}_{k} ) \\ {δ}_{k} = \frac{2}{κ} {e}_{k}\end{matrix} \\ 2. for k = κ + τ - 1 , … , τ + 1 and \\ {λ}_{κ + τ} = {( \frac{\partial h ( {x}_{κ + τ} )}{\partial {x}_{κ + τ}} )}^{T} {δ}_{κ + τ} , \text{compute:} \\ \begin{matrix}{λ}_{k} = {( \frac{\partial f ( {x}_{k} , {u}_{k + 1} )}{\partial {x}_{k}} + \frac{\partial f ( {x}_{k} , {u}_{k + 1} )}{\partial {u}_{k + 1}} \frac{\partial g ( {r}_{k + 1} , {x}_{k} , w )}{\partial {x}_{k}} )}^{T} {λ}_{k + 1} + \\ {( \frac{\partial h ( {x}_{k} )}{\partial {x}_{k}} )}^{T} {δ}_{k}\end{matrix} \\ 3. for k = τ + 1 , … , τ + κ , \text{compute:} \\ {β}_{k} = {( \frac{\partial f ( {x}_{k - 1} , {u}_{k} )}{\partial {u}_{k}} )}^{T} {λ}_{k} \\ 4. compute the gradient \frac{\partial J}{\partial w} \text{:} \\ \frac{\partial J}{\partial w} = - {\sum }_{k = τ + 1}^{τ + κ} {β}_{k}^{T} \frac{\partial g ( {r}_{k} , {x}_{k - 1} , w )}{\partial w}\end{matrix}$$

The gradient

$$\frac{\partial J}{\partial w}$$

is a moving average of the κ samples in the window. With its value, the weight vector w can be updated using equation 13.

Once the Neurointerface is trained, it can be used to control the plant. Referring to FIG. 17, the human command input to the Neurointerface causes the plant output to respond as if the cascade of Neurointerface 191 and plant 194 were equivalent to the reference model 215.

The system of FIG. 17 can be used to control a backing truck with trailer or trailers. The command input comes from the joystick operated by the truck driver. The output of the Neurointerface determines the steering angle θ₁ of the truck front wheels. The state variables θ₂ and θ₃ are fed back to the Neurointerface which contains the stabilization feedback circuit and the disturbance canceling circuit. From the point of view of the driver, the functioning of the system would be very similar to that of the system of FIG. 7.

The system of FIG. 17 can also be used to control the construction crane shown in FIG. 15. Here, the inputs to the Neurointerface are the joystick outputs and the state variables θ₂,

$$\frac{\partial {θ}_{2}}{\partial t} , {θ}_{3} , and \frac{\partial {θ}_{3}}{\partial t} .$$

The outputs of the Neurointerface are variables to be controlled, l₁, l₂ and θ₁. The components of the joystick position will control the corresponding components of the load velocity vector.

The system of FIG. 17 can further be used to control the robot arm shown in FIG. 16. The inputs to the Neurointerface are the three joystick outputs and the six state variables θ₁, and its time derivative

$$\frac{\partial {θ}_{1}}{\partial t} ,$$

θ₂, and its time derivative

$$\frac{\partial {θ}_{2}}{\partial t} ,$$

and θ₃, and its time derivative

$$\frac{\partial {θ}_{3}}{\partial t} .$$

The outputs of the Neurointerface are the three variables to be controlled, τ₁, τ₂, and τ₃. The components of the joystick position will directly control the corresponding positional components of the effector.

Obstacle avoidance is an important capability that can be incorporated into systems controlled by Neurointerfaces. When backing a trailer truck, operating a construction crane, or operating a multi-link robot, there is always concern about crashing into obstacles. Automatic obstacle avoidance can be achieved even while following, as closely as possible, the human command input.

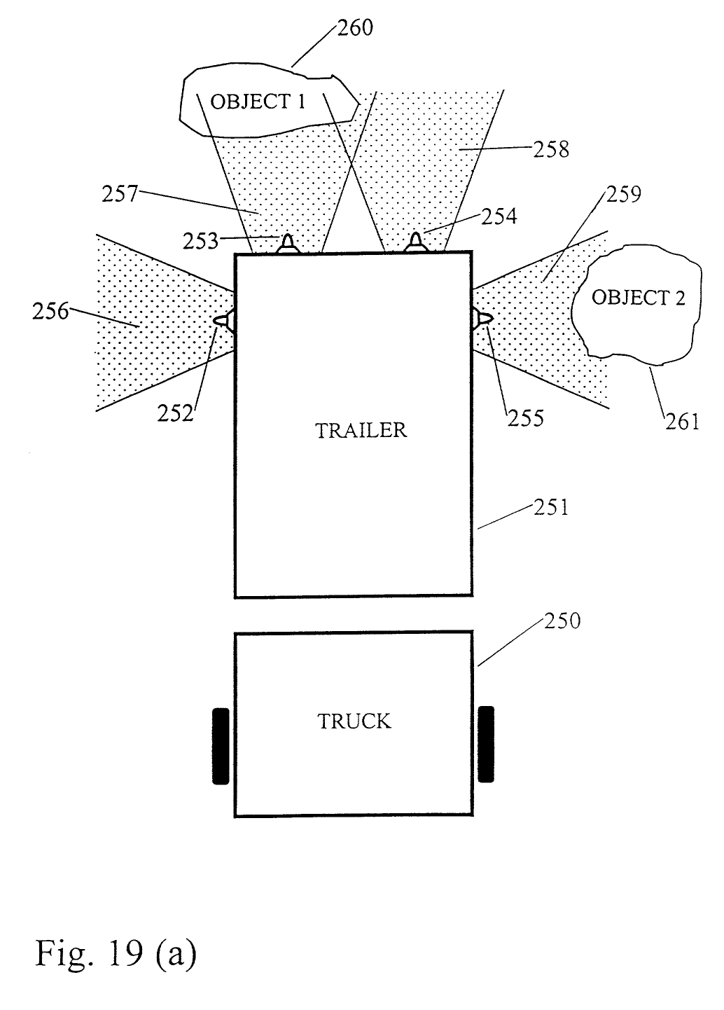

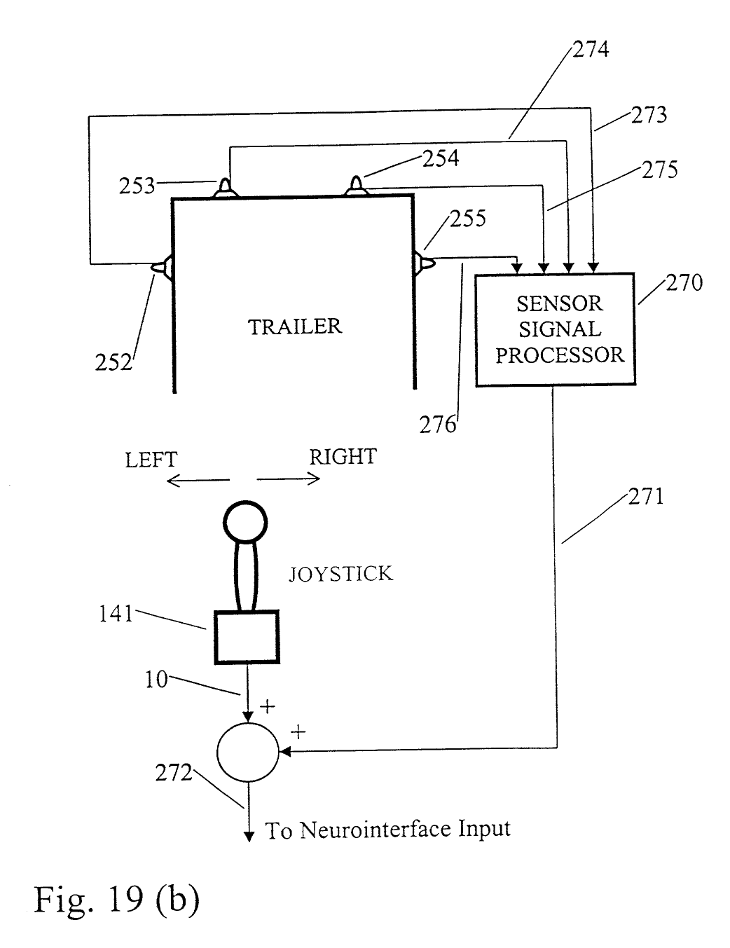

FIG. 19 (a) shows a plan view of a truck 250 and trailer 251. The trailer is equipped with proximity sensors 252, 253, 254, and 255. The sensors can be acoustic, radar, optical, TV camera, etc. Within its beam or sector of sensitivity, each sensor yields an indication of presence of an object, size of the object, and its distance from the sensor. The beam or sector of sensitivity for sensor 252 is for example, 256, as shown in FIG. 19 (a).

To avoid hitting various objects while backing, information from the sensors is superposed on the command input signal coming from the joystick. It can work as if the truck driver operated the joystick to steer the truck and trailer away from the obstacles. Actually, the driver steers with the joystick without concern for the obstacles. Obstacle avoidance is done automatically.

The presence of an obstacle such as object 2, 261, detected by sensor 255 would add a signal to the joystick output signal to cause the truck and trailer to curve away from object 2. The presence of object 1 260 would add an additional signal to the joystick output signal to cause the truck and trailer to also curve away from object 1. The closer the object is to the trailer, the stronger is the signal added to the joystick output. The added sensor signals, when the obstacle is close, can be strong enough to overpower the joystick output signal. If any of the sensors detects an object that is at a too-close limit, the truck is stopped. The driver will pull forward and try backing again.

FIG. 19 (b) shows the wires 273, 274, 275, and 276 carrying the outputs of sensors 252, 253, 254, and 255 respectively to a sensor signal processor 270. The output 271 of the signal processor is added to the output 10 of the joystick 141. The sum 272 is applied as the new input to Neurointerface 8 in FIG. 14. The sensor signal processor uses information from the sensors about the sensor beams or sectors that contain obstacles, the distance to these obstacles, and how big they are, in order to determine the amplitude and polarity of the signal 271.

Referring to FIG. 19 (a), sensor 253 would detect object 1, 260. Sensor 254 would also detect this object, but would receive a smaller signal. This would cause an output 271 that would steer the truck and trailer system so that the rear of the trailer 251 would turn toward the right. The closer the rear of the trailer is to object 1, the stronger is signal 271, causing sharper steering to the right to avoid object 1. If the trailer in turn comes too close to object 2, the rear of the trailer will be steered to the left to avoid it. With the same proximity to object 1 and object 2, the sensor signal processor 270 is designed so that there will be a stronger tendency to steer away from objects in beams pointing backward from the trailer, such as 257 and 258, than to steer away from beams pointing to the sides such as 256 and 255. If the trailer comes too close to any of the sensors, the truck is stopped. This scheme works well and allows the truck driver to steer the truck as desired, and to avoid the obstacles without needing to steer around them. Once passing the obstacles, signal 271 goes to zero and normal joystick steering control resumes.

It is possible to place more sensors on the single trailer. It is also possible to do obstacle avoidance with a truck and two or more trailers. Proximity sensors would be placed on the truck and all the trailers. The principles of operation are the same. The sensor signal processor 270 would need to be a nonlinear combiner, such as a neural network. It would be trained off-line by simulation to interpret the pattern of sensor outputs to produce an output 271 that would allow the driver to steer as well as possible, but to avoid obstacles without explicitly steering around them. Training of the sensor signal processor is done by simulating many backing scenarios with different desired trajectories and obstacle placements. By computing the sensor output pattern and the desired steering signal 271, a set of input patterns and associated desired responses would then be available for training the neural network by means of the backpropagation algorithm of Werbos [3].

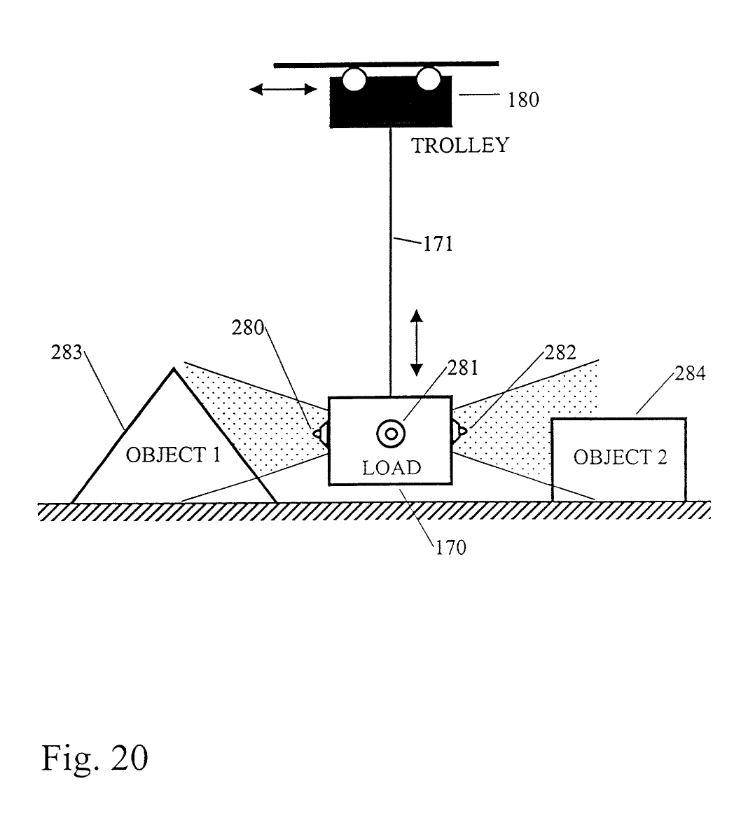

These same methods can be used for obstacle avoidance with human operation of a construction crane. By placing proximity sensors on the load 170, as shown in FIG. 20, and by conveying their output signals to a sensor signal processor, the processed sensor signals can be used to steer the load away from obstacles. The operator is able to steer the load as well as possible along the desired path in three-dimensional space, and to avoid obstacles without needing to steer around them.

The proximity sensors are temporarily attached to the load, and can transmit their signals to the sensor signal processor by radio, by wire, or by some other means of connection. An alternative sensing scheme would use overhead downward looking stereo TV cameras that would be attached to the trolley. The neural network in the sensor signal processor would be trained to respond to TV pictures of the load and obstacles, or to the pattern of proximity sensor outputs.

The multi-link robot of FIG. 16 can also be humanly operated in conjunction with an obstacle avoidance system. Proximity sensors would be placed along the links of the robot, and their signals would connect to a sensor signal processor. This processor would be trained off-line to avoid obstacles. Human control would be done by joystick, as before.

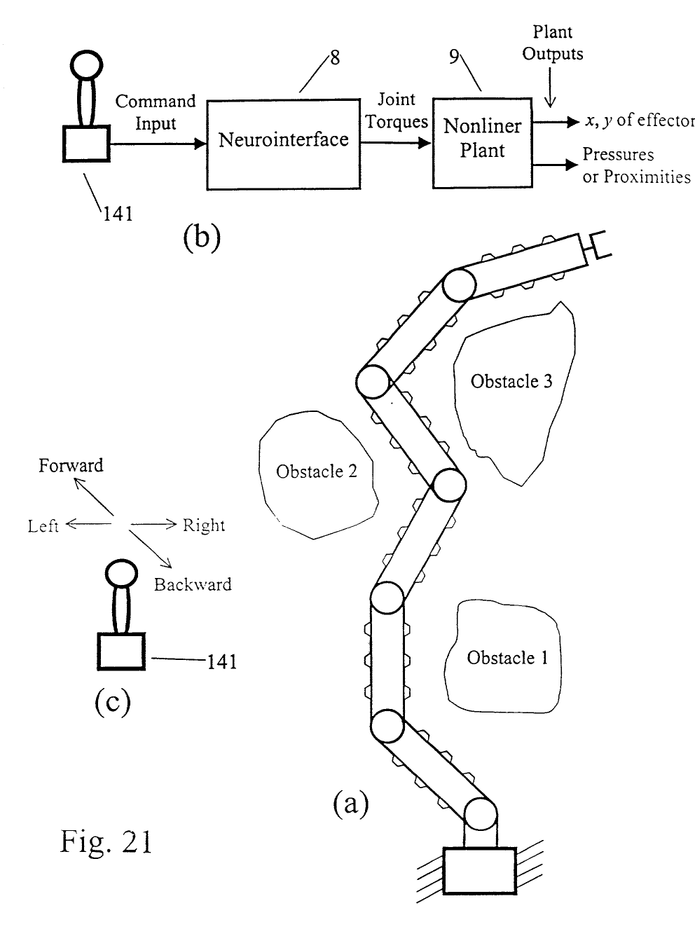

FIG. 21 (a) shows a plan view of a multi-link robot arm threading through a field of obstacles while placing the effector in a desired x, y position. In FIG. 21 (b), the joystick 141 applies a command input to Neurointerface 8, whose outputs are the joint torques. The result of application of the torques is an x, y position of the effector, and location of the robot links relative to the various obstacles. In FIG. 21 (c), the joystick command controls the x, y position of the effector. An infinite number of joint angle configurations would produce the desired x, y position. The system will obtain this position and maximize the minimum distance between the sensors and the obstacles. The outputs of the plant 9 are thus the x, y position of the effector, and the distance between the sensors and the obstacles. This kind of robot arm would be used in an industrial setting where the arm would need to be moved from one place to another without crashing into obstacles. This kind of robot arm would also be used as a tool for othroscopic surgery, threading its way for example between the organs of the abdomen or the thorax. Instead of proximity sensors, the surgical application would use pressure sensors. The objective would be to place the effector in the desired location and minimize the maximum pressure against the arm when pressing aside the internal organs.

Neurointerface designs are presented here for human operator control of a backing truck with trailers, a construction crane, and a multi-link robot arm. With obstacle avoidance circuits, the human operator is able to steer as desired, as well as possible, without needing to steer around obstacles. The same principles can be applied to ease human control of other complex machines such as aircraft and helicopters, heavy earth moving equipment, and so forth.

The above description is based on preferred embodiments of the present invention; however, it will be apparent that modifications and variations thereof could be effected by one with skill in the art without departing from the spirit or scope of the invention, which is to be determined by the following claims.

### References

[1] B. Widrow and M. Lehr, “30 years of adaptive neural networks: Perceptron, madaline, and backpropagation”, Proceedings of the IEEE, pp. 1415-1442, 1990.

[2] S. S. haykin, Neural Networks. Prentice-Hall, Inc., 1998.

[3] P. J. Werbos, Beyond Regression: New Tools for Prediction and Analysis in the Behavioral Sciences. PhD thesis, Harvard University, Boston, Mass., 1974.

[4] D. Nguyen and B. Widrow, “neural networks for self-learning control systems”, IEEE Control Systems Magazine, pp. 18-23, 1990.

[5] B. Widrow and E. Walach, Adaptive Inverse Control. Prentice-Hall, Inc., 1996.

What is claimed is:

1. A Neurointerface for receiving input signals from an operator and controlling a complex system or machine comprising:
an adaptive filter with adjustable weights connected to signal delaying elements, said adjustable weights serving as variable multipliers of their respective signals,
summation means for combining said respective signals, nonlinear devices for processing the summed signals, and
means for combining the nonlinearly processed summed signals to generate the output signals of the Neurointerface, said output signals being used to control or direct a complex system or machine.

2. The Neurointerface of claim 1 wherein said signal delaying elements receive inputs from both the input signals and the output signals of said Neurointerface.

3. The Neurointerface of claim 1 wherein said input signals from a human operator consist of a plurality of individual input signals and wherein said output signals consist of a plurality of individual output signals.

4. The Neurointerface of claim 2 wherein said input signals consist of a plurality of individual input signals and wherein said output signals consist of a plurality of individual output signals.

5. The Neurointerface of claim 1 including a cascade of Neurointerfaces wherein said adjustable weights are determined by an automatic optimization process so that the overall response of the cascade of said Neurointerface and the system to be controlled closely approximates the human command input to said Neurointerface.

6. The Neurointerface of claim 1 including a cascade of Neurotransmitters wherein said adjustable weights are determined by an automatic optimization process so that the overall response to the human command input to the cascade of said Neurointerface and the system to be controlled closely approximates the response of a reference model to said human command input.

7. A cascade of a Neurointerface and an unstable system to be controlled, wherein said system is stabilized by conventional feedback.

8. A cascade of a Neurointerface as in claim 1 and a disturbed system to be controlled, wherein said system is connected to an adaptive disturbance canceller.

9. The cascade of Neurointerface as in claim 8 wherein said adaptive disturbance canceller includes weights which are determined by an automatic optimization process to minimize disturbance of said disturbed system.

10. A Neurointerface as in claim 1 for steering, while backing only, the front wheels of a truck with a single trailer, wherein the input signal to said Neurointerface is a humanly generated command input that determines the radius of curvature of the trajectory of the truck and trailer.

11. A Neurointerface as in claim 1 for steering, while backing only, the front wheels of a truck with a plurality of trailers, wherein the input signal to said Neurointerface is a humanly generated command input that determines the radius of curvature of the trajectory of the truck and trailers.

12. The Neurointerface and truck with trailer of claim 10, wherein state variable feedback is used to stabilize the backing truck and trailer, the state variable being the angle θ₂ between the truck and the trailer.

13. The Neurointerface and truck with trailers of claim 11, wherein state variable feedback is used to stabilize the backing truck and trailers, the state variables being the angle θ₂ between the truck and the first trailer, the angle θ₃ between the first and second trailer, θ₄ the angle between the second and third trailer, and so forth.

14. A Neurointerface as in claim 5 for human control of a backing truck and trailers, wherein said Neurointerface is automatically optimized to minimize the mean square error between the humanly applied command input as filtered by a reference model and the angle between the last and the next to last trailers.

15. A truck with a single trailer steered while backing by a human providing command inputs to a Neurointerface as in claim 1, wherein said truck with a single trailer is connected to an adaptive disturbance canceller, said adaptive disturbance canceller optimized to minimize disturbance effects in said truck with a single trailer.

16. A truck with a plurality of trailers steered while backing by a human providing command inputs to a Neurointerface as in claim 1, wherein said truck with a plurality of trailers is connected to an adaptive disturbance canceller, said adaptive disturbance canceller optimized to minimize disturbance effects in said truck with a plurality of trailers.

17. A Neurointerface as in claim 2 for controlling boom angle, position of trolley on said boom, and length of support cable of a construction crane, wherein the input signals to said Neurointerface are command inputs of a human operator provided to determine the position in three-dimensional space of the load supported by said support cable.

18. The Neurointerface of claim 17, wherein said humanly-generated command inputs are applied to said Neurointerface by means of a three-dimensional joystick.

19. The Neurointerface and construction crane of claim 17, wherein state variable feedback is used to stabilize said construction crane, the state variables being θ₂, the angle between the load support cable and the boom, and its time derivative
$$\frac{\partial {θ}_{3}}{\partial t} ,$$
and θ₃, the angle between said load support cable and a horizontal line perpendicular to the boom, and its time derivative
$$\frac{\partial {θ}_{3}}{\partial t} .$$

20. A Neurointerface as in claim 1 for human control of a construction crane, wherein said Neurointerface is optimized to minimize the mean-square error between the three-dimensional operator-applied command input as filtered by a reference model and the corresponding three components of velocity of the load.

21. A construction crane with a cable-supported load controlled by a human operator providing command inputs to a Neurointerface as in claim 1, wherein said construction crane is connected to an adaptive disturbance canceller, said adaptive disturbance canceller optimized to minimize disturbance effects in said construction crane.

22. A Neurointerface as in claim 1 for controlling the joint torques of a robot arm, wherein the input signals to said Neurointerface are humanly-generated command inputs that determine the position of the effector of said robot arm in three-dimensional space.

23. The Neurointerface and robot arm of claim 23, wherein state variable feedback is used to stabilize said robot arm, the state variables being the joint angles of said robot arm and their respective time derivatives.

24. A Neurointerface as in claim 1 for human control of a robot arm, wherein said Neurointerface is optimized to minimize the mean square error between the three-dimensional humanly-applied command inputs as filtered by a reference model and the corresponding three components of position of the effector of said robot arm.

25. A robot arm controlled by a human operator providing command inputs to a Neurointerface as in claim 1, wherein said robot arm is connected to an adaptive disturbance canceller, said adaptive disturbance canceller optimized to minimize disturbance effects in said robot arm.

26. A Neurointerface containing a neural network, said Neurointerface receiving command input signals from a human operator and serving as a coupling between the human operator and the plant, system, or complex machine to be directed or controlled, said Neurointerface also receiving input signals which are the state variable signals of said plant to be controlled, said command input signals and said state variable signals providing inputs to said neural network, said inputs applied to adjustable weights which serve as variable multipliers for said inputs, summation means for combining the weighted signals, nonlinear devices for processing the summed signals, means for combining the nonlinearly processed summed signals to generate the output signals of the Neurointerface, said output signals being used to control or direct said plant or said complex machine.

27. The Neurointerface of claim 26, wherein said nonlinearly processed summed signals are further weighted with variable weights, summed, nonlinearly processed, and finally combined to generate the Neurointerface outputs.

28. The Neurointerface of claim 27, wherein said Neurointerface is trained to provide input signals to the plant or complex machine to be controlled so that the differences between the plant output signals and the corresponding output signals of a reference model are minimized in the mean square sense, when the command input is applied to both said Neurointerface and said reference model.

29. The Neurointerface of claim 28, wherein said Neurointerface is also trained to stabilize said plant.

30. The Neurointerface of claim 29, wherein said Neurointerface is also trained to provide disturbance canceling for said plant.

31. The Neurointerface of claim 3, wherein said Neurointerface is connected to an obstacle avoidance system, said avoidance system comprised of proximity sensors, a sensor signal processor, a summer that combines the output of said sensor signal processor with said input signals from a human operator.

32. The Neurointerface of claim 10, wherein said Neurointerface is connected to an obstacle avoidance system, said avoidance system comprised of proximity sensors attached to the truck and trailer, a sensor signal processor, a summer that combines the output of said sensor signal processor with said humanly generated command input.

33. The Neurointerface of claim 11, wherein said Neurointerface is connected to an obstacle avoidance system, said avoidance system comprised of proximity sensors attached to the truck and trailers, a sensor signal processor, a summer that combines the output of said sensor signal processor with said humanly generated command input.

34. The Neurointerface of claim 22, wherein said Neurointerface is connected to an obstacle avoidance system, said avoidance system comprised of proximity sensors attached to the links of the robot arm and to the effector, a sensor signal processor, a summer that combines the outputs of said sensor signal processor with said humanly-generated command inputs.

35. The Neurointerface of claim 2, wherein said Neurointerface serves as a coupling between a human operator and a multi-link robot arm, said Neurointerface receiving a humanly-generated command input signal, the outputs of said Neurointerface controlling torques applied to the joints of the robot arm, said robot arm having links with attached proximity sensors, said sensors providing inputs to an obstacle avoidance system for the robot arm.

36. The Neurointerface of claim 2, wherein said Neurointerface serves as a coupling between a human operator and a multi-link robot arm, said Neurointerface receiving a humanly-generated command input signal, the outputs of said Neurointerface controlling torques applied to the joints of the robot arm, said robot arm having links with attached pressure sensors, said sensors providing inputs to a system that minimizes the maximum pressure on the robot arm.
